(19) United States
(12) Patent Application Publication
(10) Pub. No.: US 2026/0110485 A1
(43) Pub. Date: Apr. 23, 2026

(54) VARIABLE POWER HEATER FREEZE-DRYER APPARATUS AND METHODS OF USE

(71) Applicant: PEAK & PRAIRIE INDUSTRIES CORP., Lethbridge (CA)

(72) Inventors: Kailyn Slenders, Lethbridge (CA); William Slenders, Lethbridge (CA); Mark Guckert, Lethbridge (CA); Darren Lloyd, Lethbridge (CA)

(21) Appl. No.: 19/117,913

(22) PCT Filed: Oct. 3, 2023
(86) PCT No.: PCT/CA2023/051308

§ 371 Date: Apr. 2, 2025

Related U.S. Application Data
(60) Provisional application No. 63/412,689, filed on Oct. 3, 2022.

(51) Int. Cl. F26B 5/06; A23B 2/00; A23B 2/92; F26B 5/04; F26B 23/04

(52) U.S. Cl. CPC F26B 5/06; A23B 2/001; A23B 2/003; A23B 2/92; F26B 23/04; F26B 5/044

(57) ABSTRACT

According to embodiments, a modified freeze-drying apparatus and methods of use are provided herein for providing variable power heating for precise control of material temperatures during freeze-drying. The apparatus may provide a vacuum pump and variable current heater trays for receiving the material, freezing the material, creating a vacuum, progressively increasing the heater tray temperature without causing temperature cycling, deactivating the tray heater, repressurizing the apparatus, and removing the freeze-dried material.

### TECHNICAL FIELD

Embodiments herein are generally related to apparatus and methods for freeze-drying materials and, in some cases, to freeze-dryer apparatus and methods of use thereof.

### Background

The following paragraphs are not an admission that anything discussed in them is prior art or part of the knowledge of persons skilled in the art. Freeze-drying methods for food products often incorporate heat cycling stages where a heater is on or off depending on measured temperature in the system.

### Summary

A freeze-dryer apparatus is disclosed comprising: a cooling system; a vacuum system or a vacuum system connector; a vacuum chamber; a food tray with a temperature sensor and a variable power heater, and located within the vacuum chamber; and a controller connected to adjust and control a supply of continuous and non-zero power to the variable power heater to maintain the food tray within a predetermined range of temperature during a freeze-drying operation.

A method is disclosed comprising cooling a food tray in a vacuum chamber, the food tray having a temperature sensor and a variable power heater; evacuating air in the vacuum chamber to put the vacuum chamber under partial vacuum; and while the vacuum chamber is under partial vacuum, heating the food tray to maintain a predetermined range of temperature by applying continuous non-zero power to the variable power heater.

Embodiments of a modified freeze-drying apparatus and methods of use are provided herein. Generally, such apparatus may be used to freeze-dry material, including food and components for manufacturing. In some embodiments, the present apparatus may comprise a housing forming a freeze-drying chamber and a condenser chamber in fluid communication with the freeze-drying chamber, at least one variable current heater tray positioned within the freeze-drying chamber for receiving and heating the material, a vacuum system for evacuating air and water vapour from within the housing, and a refrigeration system for condensing water vapour within the condensing chamber. In operation, the apparatus may remove water molecules from the material by freezing the material to create ice crystals, subjecting the material to a vacuum, progressively increasing the temperature of the material to cause sublimation of the ice crystals to water vapour, and sequestering the water vapour away from the material. More specifically, the at least one variable current heater tray may be operable to receive the material within the freeze-drying chamber, the refrigeration system may be operable to freeze the material, the vacuum system may be operable to create a vacuum within the housing, the at least one variable current heater tray may be further operable to increase the temperature of the material after a vacuum is created to form water vapour, and the condenser chamber may be operable to sequester water vapour away from the material by condensing the water vapour into liquid water and ice (i.e. by acting as a one-way reservoir). Such embodiments may also comprise a controller having a processor, wherein the controller controls the operation of the current controlling means and vacuum system according to measurements made by at least one temperature sensor comprised by the at least one variable current heater tray and at least one pressure sensor comprised by the vacuum system. In some embodiments, the controller may be programmed with a material-specific recipe by an operator of the apparatus or a machine learning (AI) system.

According to embodiments, a modified freeze-drying apparatus and methods of use are provided herein for freeze-drying a material. The present apparatus may comprise: a housing forming a freeze According to embodiments, a modified freeze-drying apparatus and methods of use are provided herein for freeze-drying a material. drying chamber and a condenser chamber in fluid communication with the freeze-drying chamber, the freeze-drying chamber and condenser chamber substantially partitioned by a partition; at least one variable current heater tray positioned within the freeze-drying chamber for receiving and heating the material, the variable current heater tray having at least one variable current heater for receiving current from a power source and increasing the temperature of the variable current heater tray, at least one current controlling means for varying the current received by the at least one variable current heater, and at least one temperature sensor for measuring the temperature of the at least one variable current heater tray; a vacuum system for evacuating air and water vapour from within the housing, the vacuum system comprising a vacuum pump in fluid communication with the housing and at least one pressure sensor for measuring pressure within the body; and a refrigeration system for condensing water vapour within the condensing chamber, the refrigeration system comprising a compressor, at least one condenser coil in fluid communication with the compressor, and a refrigerant disposed therein. Such embodiments may also comprise a controller having a processor, wherein the controller controls the operation of the current controlling means and vacuum system according to measurements made by the at least one temperature sensor and pressure sensor. In some embodiments, the controller may be programmed with a material-specific recipe by a user of the apparatus.

Modified methods of using the present freeze-drying apparatus are also provided. The present methods comprise providing material to be freeze-dried, providing an apparatus having a vacuum pump and variable current heater trays for receiving the material, freezing the material, creating a vacuum, progressively increasing the heater tray temperature without causing temperature cycling, deactivating the tray heater, repressurizing the apparatus, and removing the freeze-dried material.

As will be appreciated from the disclosures herein, the present apparatus and methods of use may provide non-cyclical, progressively increasing material temperatures during freeze-drying, which may further provide reduced drying time, reduced risk of heat damage to material, increased energy efficiency, enhanced scale-up in terms of chamber volume and material capacity, and simplified operation and programming by the operator compared to other known methods.

In various embodiments, there may be included any one or more of the following features: The variable power heater comprises a variable current heater. A direct current (DC) power supply is connected to supply power to the variable current heater. The cooling system is connected to cool the vacuum chamber. The cooling system is connected to supply and return coolant to and from the vacuum chamber via a coolant loop. The coolant loop comprises a coolant coil that encircles the vacuum chamber. The vacuum chamber is defined by a vacuum chamber housing with side walls, a top, a base, a front, and rear wall; and the coolant coil loops a plurality of times around the side walls, top, and base. An insulative shroud is around an exterior of the vacuum chamber. The vacuum chamber is fluidly connected to vent evacuated air from the vacuum chamber to a condenser chamber. The vacuum system comprises or is configured to connect to a vacuum pump that is connected to evacuate air from the vacuum chamber via a vacuum line. An access door is mounted to seal and unseal against a tray entry opening defined by the vacuum chamber. The access door is mounted to a front of the vacuum chamber; and a drip tray depends below the access door. A pressure sensor is in the vacuum chamber, in which the controller is connected to control operation of the freeze-drying operation based on data from the pressure sensor. A fan is configured to operate with the cooling system to blast chill an interior of the vacuum chamber during a freezing phase of a freeze-drying operation. The controller is configured to operate a freeze-drying operation by initiating, in sequence: a vacuum freeze mode which operates until air pressure is reduced in the vacuum chamber to at or below a threshold pressure; a first heating phase where the supply of continuous and non-zero power to the variable power heater is adjusted to maintain the food tray at a first rate of temperature increase; and a second heating phase where the supply of continuous and non-zero power to the variable power heater is adjusted to maintain the food tray at a second rate of temperature increase that is higher than the first rate of temperature increase. The controller is configured to initiate a stall phase during one or both the first heating phase or the second heating phase when a pressure within the vacuum chamber remains above a high-pressure threshold for more than a predetermined amount of time. The controller is configured to operate the stall phase by: shutting off power to the variable power heater; and returning to the first heating phase or second heating phase when a pressure within the vacuum chamber drops below the low-pressure threshold. The controller is configured to store or access a database of freeze-drying operation recipes, and to display an edit-recipe user interface configured to allow a user to edit existing recipes and create novel recipes, which the controller is configured to store in the database for future use in a freeze-drying operation to be carried out by the freeze-dryer apparatus. The food tray comprises a plurality of food trays, and the controller is connected to independently adjust and control a supply of continuous and non-zero power to the respective variable power heater of each respective food tray to maintain each food tray within a respective predetermined range of temperature during a freeze-drying operation. Using the freeze-dryer apparatus of any one of claim 1-18 to freeze-dry food. Applying further comprises sensing a temperature of the food tray; and adjusting the continuous non-zero power to maintain the predetermined range of temperature. Cooling comprises blast chilling an interior of the vacuum chamber. Heating further comprises: adjusting the continuous non-zero power to maintain the food tray at a first rate of temperature increase when in a first heating phase; and after the food tray climbs to a predetermined threshold temperature, adjusting the continuous non-zero power to maintain the food tray at a second rate of temperature increase, when in a second heating phase, that is higher than the first rate of temperature increase. Initiating a stall phase during one or both the first heating phase or the second heating phase when a pressure within the vacuum chamber remains above a high-pressure threshold for more than a predetermined amount of time.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

Embodiments of a first freeze-dryer apparatus are disclosed herein with reference to the following FIGS. 1-7.

FIG. 1 is a perspective view of a freeze-dryer apparatus.

FIG. 2 is a perspective view of a vacuum chamber of the freeze-dryer apparatus of FIG. 1, with the location of an embedded temperature sensor shown in dashed lines. FIG. 2A is a bottom plan view of a food tray used in the apparatus of FIG. 1.

FIG. 3 is a partially exploded view of the vacuum chamber of FIG. 2.

FIG. 4 is a top plan view of the vacuum chamber of FIG. 2.

FIG. 5 is a front-end view of the freeze-dryer apparatus of FIG. 1.

FIG. 6 is a side elevation view of the freeze-dryer apparatus of FIG. 1.

FIG. 7 is a section view taken along the 7-7 section lines in FIG. 5.

FIG. 8 is a flow diagram of a series of phases in a freeze-drying operation.

FIG. 9 is a flow diagram of a pre-freeze phase.

FIG. 10 is a flow diagram of a cooling phase (standard freeze).

FIG. 11 is a flow diagram of a vacuum freeze phase.

FIG. 12 is a flow diagram of a heating phase.

FIG. 13 is a flow diagram of a stall phase.

FIG. 14 is a flow diagram of a process complete phase.

FIG. 15 is a flow diagram of a defrost phase.

FIG. 16 is a screenshot of an intro page of an example user interface (UI) for operating the freeze-dryer apparatus of FIG. 1.

FIG. 17 is a screenshot of a system start page of an example user interface (UI) for operating the freeze-dryer apparatus of FIG. 1.

FIG. 18 is a screenshot of a system status page of an example user interface (UI) for operating the freeze-dryer apparatus of FIG. 1.

FIG. 19 is a screenshot of a recipes and programming page of an example user interface (UI) for operating the freeze-dryer apparatus of FIG. 1.

FIG. 20 is a screenshot of an edit recipe page of an example user interface (UI) for operating the freeze-dryer apparatus of FIG. 1.

FIG. 21 is a screenshot of a manual control page of an example user interface (UI) for operating the freeze-dryer apparatus of FIG. 1.

FIG. 22 is a screenshot of a system status page with a warning pop-up after a process complete selection, of an example user interface (UI) for operating the freeze-dryer apparatus of FIG. 1.

FIG. 23 is a screenshot of a system status page with a warning pop-up after a defrost selection, of an example user interface (UI) for operating the freeze-dryer apparatus of FIG. 1.

FIG. 24 is a screenshot of a settings and support page of an example user interface (UI) for operating the freeze-dryer apparatus of FIG. 1.

FIG. 25 is a screenshot of a cooler test page of an example user interface (UI) for operating the freeze-dryer apparatus of FIG. 1. Embodiments of a second freeze-dryer apparatus are disclosed herein with reference to the following FIGS. 26-32.

FIG. 26 is a side perspective view of a further freeze-drying apparatus.

FIG. 27 is a cross sectional side view of the apparatus shown in FIG. 26;

FIG. 28 is a detailed cross sectional side view of a freeze-drying chamber and condenser chamber comprised by the apparatus shown in FIG. 26;

FIG. 29 is a front-end view of the freeze-drying chamber shown in FIG. 28;

FIG. 30 is a side elevation view of the freeze-drying chamber shown in FIG. 28; FIG. 30 is a close-up view from FIG. 27, illustrating a controller.

FIG. 31 is a front elevation view of the apparatus of FIG. 26.

FIG. 32 is a flow diagram of a method of operating the freeze-dryer apparatus of FIG. 26.

### DETAILED DESCRIPTION

Immaterial modifications may be made to the embodiments described here without departing from what is covered by the claims.

The terms “freeze-drying,” “lyophilization,” and “cryodesiccation” refer to a group of related methods for removing water molecules from a material. The methods generally comprise (i) lowering material temperature so that water molecules freeze and form ice crystals, (ii) lowering atmospheric pressure and increasing material temperature so that the ice crystals sublimate and form water vapour, and (iii) removing the water vapour to yield the freeze-dried material. Specifically, these methods lower the material temperature and atmospheric pressure to below the triple point for water (273.16 Kelvin and 611.73 Pascals). Triple point refers to the temperature and pressure conditions at which solid, liquid, and gas phases are in equilibrium. When temperature and pressure conditions are lowered below the triple point for water, these conditions result in the sublimation of solid water (i.e., ice) directly to gaseous water (i.e., water vapour) without the formation of liquid water. Following sublimation of ice crystals within the material being freeze-dried, the formed water vapour diffuses away from the material, resulting in a convenient, efficient, and gentle method for dehydrating the material compared to other known dehydration methods (e.g., boiling, applying desiccants such as salt, etc.). Freeze-drying methods are particularly advantageous because they remove water molecules from a material without subjecting the material to structural modifications or damage caused by liquid water or additives such as desiccants.

Freeze drying, also known as lyophilization, is a sophisticated and widely used dehydration process employed in various industries, including pharmaceuticals, food preservation, and biotechnology. This technique involves the removal of moisture from a substance by first freezing it and then subjecting it to a controlled vacuum environment. During the process, the substance is frozen, typically below its triple point, which allows the water within it to transition directly from a solid (ice) to a vapor (sublimation) without passing through the liquid phase. This sublimation process results in the removal of water molecules, leaving behind a dry and stable product with minimal damage to its structure and biological activity. Freeze drying is favored for its ability to preserve the integrity of heat-sensitive materials and is crucial in the production of pharmaceuticals, high-quality instant coffee, and the long-term storage of various biological samples, such as vaccines and freeze-dried fruits.

There are several methods employed to freeze dry materials, each with its own advantages and applications. The most common approach involves placing the material in a freeze dryer chamber and subjecting it to a gradual reduction in temperature. Initially, the material is cooled to freezing temperatures, typically below −40° C. (−40° F.), causing the water within it to freeze. Subsequently, a vacuum is applied, creating a low-pressure environment that facilitates sublimation, wherein the frozen water transforms directly into vapor without passing through a liquid phase. This method is highly effective for a wide range of materials, from pharmaceuticals to food products. Another technique, known as tray freezing, involves spreading the material on trays or shelves within a freezing chamber and then transferring them to a separate freeze dryer for sublimation. Additionally, spray freeze drying is utilized for liquid materials, where a fine mist or droplets are rapidly frozen in a cold environment and then subjected to vacuum conditions for drying. Each of these methods has specific advantages and is selected based on the characteristics of the material being processed and the desired end product properties.

Known freeze-drying methods have applications in the material processing industry, namely for food preservation and component manufacturing. For example, freeze-drying food can yield shelf-stable, non-perishable food products with superior flavour and nutritional value compared to other preserved food products. Freeze-drying may also be used to manufacture components for industrial applications, such as cathodes and other dehydrated compounds for lithium-ion batteries. It will be appreciated that freeze-drying methods are known to have many other applications and may be used with many different types of materials. It will also be appreciated that freeze-drying methods are known to vary between applications and materials to be freeze-dried. Such material-specific methods are generally referred to as “recipes.”

Freeze-dried food finds extensive applications across a range of industries due to its lightweight, long shelf life, and retention of nutritional value and flavor. In the food industry, freeze-drying is commonly used for the production of lightweight, shelf-stable products such as instant coffee, soups, and freeze-dried fruits and vegetables. These products rehydrate quickly and maintain their original taste and nutritional content, making them suitable for both camping and emergency food supplies. In the pharmaceutical sector, freeze-drying is instrumental for preserving sensitive drugs and vaccines, as it eliminates the need for preservatives and ensures longer shelf life while maintaining the potency of these critical substances. Additionally, in the field of biotechnology, freeze-drying is employed to preserve enzymes, bacteria, and other biological samples for research and diagnostic purposes. Its applications also extend to the preparation of space food for astronauts, as freeze-dried meals are compact, lightweight, and capable of retaining nutrients during extended missions in space. Overall, the versatility of freeze-dried food makes it indispensable in various fields where preservation, convenience, and nutrition are essential considerations.

Freeze-drying methods are performed using freeze-drying apparatuses. Known apparatus typically comprise (i) a chamber for receiving the material to be freeze-dried, (ii) a vacuum system for decreasing atmospheric pressure within the chamber, (iii) a heater for heating the material to be freeze-dried, and (iv) a system for removing water vapour from within the chamber. Freeze-drying apparatus are also known to be operated using a wide variety of control systems with different features. Such features may include separate chambers for freeze-drying the material and removing water vapour from the apparatus (typically by condensing the water vapour into ice or liquid water, which can be collected or drained as desired), temperature controllers programmed for a specific material, thermocouples to provide information to the temperature controller, and a programmable controller to receive instructions from an operator. Additionally, solid state relays, switches, and digital and analog devices, including electronic controllers and processors, allow a desired recipe to control the freeze-drying process. Unfortunately, such known apparatus requires operators to have significant understanding of the freeze-drying process in order to adequately set up the process controls for a particular recipe. Known apparatuses may also incorporate glycol-based systems, or other systems that incorporate harmful materials, which are generally undesirable.

One known method of using a freeze-drying apparatus is disclosed in U.S. Pat. No. 9,459,044 (Haddock). The Haddock method comprises pressure-activated heater activation, in which the material heater is activated and deactivated according to water vapour pressure within the freeze-drying chamber of the apparatus. The pressure-activated heater activation results in heater cycling between at least one lower temperature and at least one higher temperature, which is intended to prevent the material from being over-heated, which could result in thawing of the ice crystals to liquid water or heat damage to the material. This temperature control, in turn, is intended to automate and simplify the freeze-drying process for the benefit of the operator. Although the Haddock method achieves pressure-activated heater activation, it suffers from several limitations including extended drying time, risk of heat damage to material, poor energy efficiency, limited scale-up in terms of chamber volume and material capacity, and the introduction of new parameters that need to be programmed by the operator. These limitations arise, in part, because of the heater cycling repeatedly between lower temperatures and higher temperatures during each stage of the drying process. For example, the apparatus disclosed in the Haddock reference may experience 200 or more heater activations and deactivations during the freeze-drying process, which also tend to strain the activation and deactivation relays within the apparatus and may lead to a reduced operational lifespan.

Another known freeze-drying apparatus and method of use are disclosed in CN114184005A (Tianjin University). The Tianjin University reference discloses a heater system comprising weight and temperature sensors that allow for real-time monitoring and temperature control of the material to be freeze-dried. The apparatus and method are configured to detect automatically when the water in the material is completely sublimated, with the intent to automate and simplify the freeze-drying process for the benefit of the operator. The weight and temperature signals are used to determine when a primary drying stage at a first temperature range is complete and the temperature of the heating plate should be increased to a second temperature range for a secondary drying stage. The heating temperature of the material is adjusted through the control panel and the drying temperature is controlled within a reasonable range according to the actually measured material temperature, which may shorten the drying time, may improve drying efficiency, and may make the drying device more suitable for freeze-drying thermosensitive materials such as medicines, foods, and the like. Problematically, however, the two drying stages still incorporate temperature cycling within the first and second temperature ranges, with an on/off heater control that is similar to that disclosed in the Haddock reference. Accordingly, the apparatus and methods disclosed in the Tianjin University reference suffers from the same limitations as the apparatus disclosed in Haddock reference.

A suitable freeze-drying apparatus and method of use would provide reduced drying time, reduced risk of heat damage to material, increased energy efficiency, enhanced scale-up in terms of chamber volume and material capacity, and simplified operation and programming by the operator.

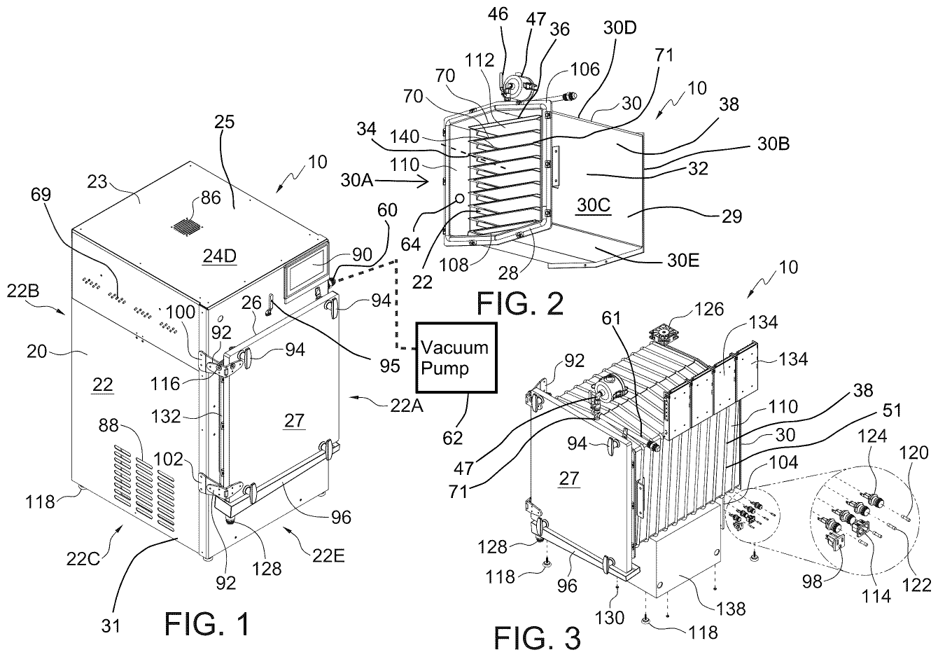

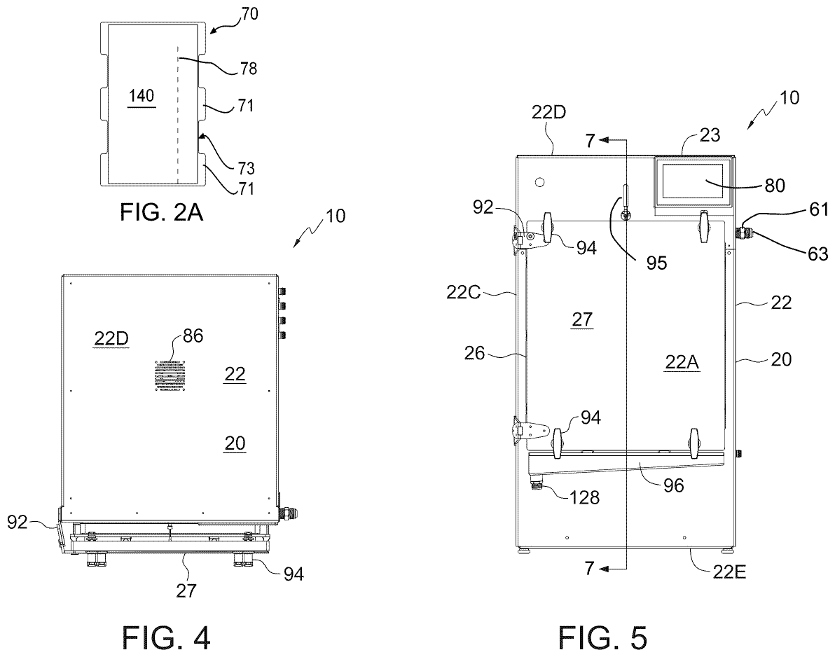

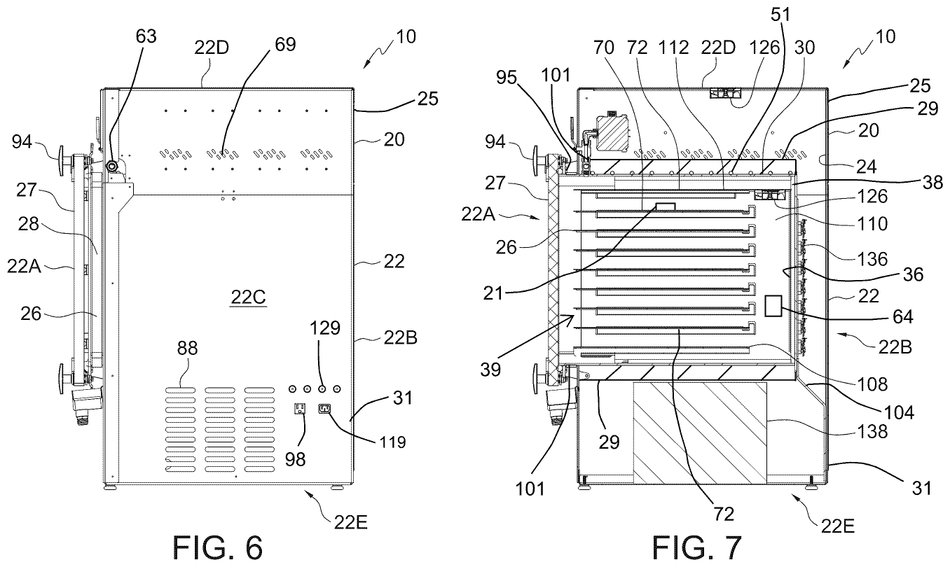

Referring to FIGS. 1 and 4-7, a freeze-dryer apparatus 10 is illustrated. Apparatus 10 may comprise a cooling system 42, such as a refrigeration system. The apparatus 10 may comprise a vacuum system 60, for example a vacuum line 61 with a vacuum connector that is configured to connect to an integrated or external vacuum pump 62. In the example shown, the apparatus 10 may comprise a vacuum chamber 30. The apparatus 10 may comprise a food tray 70. Referring to FIG. 2A, the food tray 70 may have a temperature sensor 78. The food tray 70 may have a variable power heater, such as a variable current heater 140, shown as a pad in the example of FIG. 2A. Referring to FIGS. 1 and 4-7, the food tray 70 may be located within the vacuum chamber 30. The apparatus 10 may have a controller 80. The controller 80 may be connected to adjust and control a supply of continuous and non-zero power to the variable power heater 140, to maintain the food tray 70 within a predetermined range of temperature during a freeze-drying operation. Referring to FIG. 7, in use, the apparatus 10 may be used to freeze-dry food 21, via a suitable operation. The food tray 70 may be positioned in vacuum chamber 30. Air may be evacuated in the vacuum chamber 30 to put the vacuum chamber 30 under partial vacuum. While the vacuum chamber 30 is under partial vacuum, the food tray 70 may be heated to maintain a predetermined range of temperature by applying continuous non-zero power to the variable power heater 140. In some cases, the range of temperature is selected to increase progressively over time. By using a variable power heating element, the amount of power provided by the controller can be adjusted and tailored precisely to retain the heater 140 in an on position throughout a heating phase of a freeze-drying operation. By retaining the heater 140 in an on position, and dialing back or increasing power to compensate for minor temperature overages or drops, the heater 140 remains on, as opposed to cycling on and off, which is relatively more energy-intensive. Moreover, by permitting precise adjustment of the application of heat, the integrity of the food is protected because the food is not subjected to extreme local temperature changes that are typical with an on-off power-cycled heater.

Referring to FIGS. 1-7, the apparatus 10 may have a suitable outer housing 20. The outer housing 20 may have various parts, such as one or more side walls 22, for example a front side wall 22A, a rear side wall 22B, and side walls 22C. A top wall 22D and a base 22E may also be defined. The housing 20 may be formed by plural parts that reversibly connect and separate from one another, such as a top hat part 25 and a base part 31. In the example shown, the top hat part 25 may hold the electronics and control parts of the apparatus 10, while the base part 31 may hold the vacuum chamber 30 and cooling system 42. The housing 20 may include suitable venting for air flow in and/or out of the housing 20, such as vents 88 for vacuum pump 62, vents 69 for DC power supply units 134, and/or vents 86 for cooling the electronics in the top hat part 25. The fan 126 in top hat part 25 may blow air up and out, to vacate the heat being generated, from the condenser, and the electronics, similar to a fan on a computer board. The use of a part such as top hat part 25 to house electronics may provide a modular benefit, as the electronics may be easily replaced by replacing the top hat part 25, leaving the rest of the machine intact. The housing 20, for example side wall 22C, may provide a mounting location for various fuses, such as female receptacle 98, IEC C14 Male Receptacle, snap-in panel mount part 114, and panel mount holder 124 for glass and ceramic tube fuses, such as glass tube fuses 120 and 122. In some cases, other types of fuses may be used, such as thermal pop fuses, which may incorporate bimetallic connectors that pop out of connection under current overload, instead of burning out like a glass fuse. One or more levelling feet 118 may be provided as ground-engaging levelling adjustment devices.

Referring to FIGS. 1-7, an access door 27 may be mounted to seal and unseal against a tray entry opening defined by the vacuum chamber 30. The front side wall 22A, or another suitable location on housing 20, may define a suitable aperture 26 for mounting a door 27. In the example shown, a suitable door 27 may be hinged to the outer housing 20. One or more hinges 92 may mount to housing 20, for example via a hinge top mounting plate 100 and a hinge bottom mounting plate 102. One or more lock-assisting parts may be used, such as a multi-pole neodymium magnet 116 to assist with closing of the door 27. In the example shown, the door 27 comprises a flat plate, with one or more, for example four, corner latches 94 that are designed to act as locking parts that secure a periphery of an inner surface of the door 27 to the outer housing 20 and/or vacuum chamber 30. The door 27 may, when closed and locked, compress a seal 28, such as an O-ring, that is mounted within the seal retainer plate 106 on the vacuum chamber 30. The latches 94 may comprise handles that turn respective cam latches 94 that engage a rear surface of retainer plate 106 in use to squeeze the plate 106, and hence seal 28, toward the door 27. A foam strip 132 may further seal the door 27 when closed. Other types of locks and latches may be used to create an airtight seal. The door 27 or part of it may be transparent or translucent to permit a user to visually inspect the interior contents of the vacuum chamber 30 in use.

Referring to FIGS. 1-7, a drip tray 96 may be provided in a suitable location on apparatus 10 for collecting condensed evaporated water for disposal or removal. In the example, below the door 27, or at another suitable location, may be a drip tray 96. The drip tray 96 may be located to catch condensed and defrosted water collected in the apparatus 10 during use, to prevent same from spilling out when the door 27 is opened. In use, a user may unlock the bottom latches 94 first to permit drainage into tray 96, before opening the door 27. A drain, such as a ¾″ GHT male ×12″ NPT male adapter may be provided in a base of tray 96 to remove fluids from tray 96. The tray 96 is shown cantilevered off housing 20 via brackets, although other mounting mechanisms may be used. A lock 95 may be provided to secure the door 27 in the locked position. During operation the system creates a lot of condensation on the bell or face plate, so the tray is designed to capture that so there is no pool around the machine, also, is part of the drain system.

Referring to FIGS. 2, 2A, 3, and 7, the vacuum chamber 30 may have suitable parts and structure. The vacuum chamber 30 may be defined by a vacuum chamber housing 32. Housing 32 may have one or more side walls 30C, a top 30D, a base 30E, a front 30A, and a rear wall 30B. The front 30A may be an open front as shown, with or without a perimeter flange, and defining a front aperture 39. In the example shown, the front 30A has a perimeter flange defined by a seal retainer plate 106. The retainer may be made by a suitable process such as three-dimensional printing. The parts of the housing 32 may be integrally formed or otherwise mated to provide an airtight seal and a chamber that has the structural integrity to withstand vacuum pressures without implosion during use. In one case the side walls 30C, top 30D, and rear wall 30B are formed of folded metal or metal plates that are welded together. The housing 32 may define a food tray insertion axis 34. The housing 32 may define an interior 36 and an exterior 38. Within the interior 36 may be provided one or more tray mounting parts 72. The tray mounting parts 72 may have a suitable shape, such as flanges that project from the interior 36 wall to form respective shelves on opposed sides of the interior 36 to support a tray 70 in a horizontal fashion. The shelves may provide surfaces over which opposed edges or legs 71 of the trays 70, may slide over upon a tray 70 being inserted or removed from the interior 36. The legs 71 or edges of the trays 70 may have a suitable design, such as defining slots of gaps 73 between adjacent legs 71 on the same side of the tray 70 to define air passages to facilitate air flow through the vacuum chamber 30 during operation. A plurality of sets of tray mounting parts 72 may be provided, such as opposed pairs of parts 72 arrayed in spaced vertical fashion up the interior 36 of side walls 30C to permit a plurality of trays 70 to be stacked within interior 36 in spaced relationship to one another, without contacting one another to promote air flow between the trays 70, and to provide respective food mounting zones 70A on each tray 70 to accommodate a sufficient size of food 21 on each tray 70. The vacuum chamber 30 may mount within the interior 24 of the housing 20 by a suitable mechanism, such as using brackets 101 that connect to a suitable part of the interior 24, for example that connect to front wall 22A about an inner periphery of front aperture 26. The chamber 30 may be cantilevered into the interior 24 of housing 20 by brackets 101 that are spaced about the periphery of a front aperture 39 of front 30A of chamber 30. In the example shown, the chamber 30 is also supported by a chamber mounting plate 104 at a rear of the chamber 30. A fan 126, such as a submersible DC equipment cooling fan, may be provided, for example within interior 36 of chamber 30. Fan 126 may be configured to operate with the cooling system 42 to blast chill an interior 36 of the vacuum chamber 30 during a freezing phase of a freeze-drying operation. The food tray 70 may comprise a plurality of food trays, and the controller 80 may be connected to independently adjust and control a supply of continuous and non-zero power to the respective variable power heaters 140 of each respective food tray 70 to maintain each food tray 70 within a respective predetermined range of temperature during a freeze-drying operation. In the example shown, plural parts 72 may be provided, such as plural shelves 108, to mount plural trays 70. Each shelf may be connected by a suitable method, such as using shelving rack welds 112.

Referring to FIGS. 2, 2A, and 7, the variable power heater 140 may comprise a variable current heater. Variable current heaters include electrical devices designed to provide precise control over the amount of heat generated in a given system by allowing for the adjustment of the electric current flowing through the heating element. These heaters are commonly used in industrial and commercial applications where maintaining a specific temperature is critical. By modulating the current, variable current heaters can adapt to changing thermal requirements, ensuring energy efficiency and optimal performance. This level of control is typically achieved through advanced electronic controllers that monitor and adjust the current based on real-time feedback from temperature sensors or other relevant parameters. Variable current heaters offer versatility and responsiveness, making them suitable for various heating processes and applications, from plastic molding to food processing and beyond. trays have heating pad adhered below. Suitable heaters 140 may be used, such as silicone heating pads, model number HOL75634801. A DC watt heater may be used. A heating pad in the underside of the tray may respond to a control panel in the back of the machine, i.e., the PCB, which may act as a limiter and a call for how much temperature the trays need. The program may call for a certain temperature, and the board measure the temperature of each tray. The heater may have a thermocouple embedded so it can provide heat and tell how hot it is. The boards may work with the programming to adjust electrical input into the tray depending on the setting and the temp feedback. This is done specifically to prevent an on-off state in the machine. The boards may thus function at 1% continuously instead of at zero power.

Variable current heaters come in several types, each designed to meet specific heating requirements and operating principles. One common type is the variable resistance heater, which adjusts its resistance to control the current and thus the heat output. This is achieved through materials with variable resistivity or by using electronic components such as thyristors or triacs to modulate the current. Another type is the variable frequency heater, which varies the frequency of the electrical waveform to control the heating effect. Induction heaters, for example, use variable frequency to induce eddy currents in a conductive material, generating heat through electromagnetic induction. Pulse-width modulation (PWM) heaters are another category, where the current is rapidly switched on and off at variable duty cycles to control the average power delivered to the heating element. This allows for precise control of heat output without altering the voltage or current amplitude. Additionally, some variable current heaters employ phase angle control, which varies the phase angle of the AC voltage applied to the heater, effectively changing the power delivered to the load. This method is commonly used in silicon-controlled rectifier (SCR) heaters. Each of these variable current heater types has its own advantages and is suitable for specific applications, depending on factors like the required heating precision, response time, and the nature of the load being heated.

Referring to FIGS. 2, 2A, and 7, heater trays 70 may be operated by using variable current heater 140, a current controlling means such as controller 80, and temperature sensor 78. In operation, as will be described in more detail, below, variable current heater 140 may receive current from a power source (not shown) to increase the temperature of heater tray 70, controller 80 may vary the current received by heater 140 to control the temperature of heater tray 70 with a high degree of precision, and temperature sensor 78 may measure the temperature of heater tray 70 so that controller 80 may be operated as desired or programed. Heater trays 70 may each be operated independently, for example if different materials are received by different heater trays 70 or if conditions within freeze-drying chamber 30 result in a temperature differential across different heater trays 70 that requires compensation by one or more heater tray 70.

In some embodiments, the variable current heater 140 may comprise a heating element (not shown) and may be configured to allow variable current to flow through the heating element, for example zero A, 0.1 A, 0.2 A, 0.3 A, 0.4 A, 0.5 A, etc. As will be appreciated, high flux of current will result in the heating element reaching a different maximum temperature, which contrasts with on/off heating elements that may cycle between a minimum and maximum temperature using zero and maximum current. The freeze-dryer apparatus 10 may comprise a direct current (DC) power supply connected to supply power to the variable current heater 140. A variable current heater may receive current from a constant direct current (DC) power source, such as an LRS-350™ power supply unit, which permits current received by variable current heater 140 to be varied with high precision by controlling the width (i.e., frequency) of electrical pulses received by heater 140 during a heater phase. A suitable power source such as a 48V DC unit may be used. Controller 80 may be configured to control the width of electrical pulses received by variable current heater 140, or may instruct other parts to control such pulses to achieve the desired current. For example, if a desired temperature of heater tray 70 corresponds with heater 140 operating at 1% maximum capacity, the controller 80 may control the frequency of pulses received by heater 140 so that pulses are received for 1% of the heater phase. The DC power source may determine the maximum capacity of heater 140 (i.e., maximum number of pulses that may be received by heater 140 during the heater phase), for example 1000 Hz.

Referring to FIG. 2, and 7, freeze-dryer apparatus 10 may comprise a pressure sensor 64 in the vacuum chamber 30. Pressure sensors are essential devices used to measure and monitor the pressure of gases in various industrial, automotive, and consumer applications. These sensors play a crucial role in ensuring the proper functioning and safety of many systems. There are several types of pressure sensors, each tailored to specific requirements. Piezoresistive Pressure Sensors: These sensors employ the piezoresistive effect, where the resistance of a material changes in response to mechanical stress. Piezoresistive pressure sensors typically consist of a diaphragm with piezoresistive elements, and they are highly sensitive and capable of measuring a wide range of pressures. They are commonly used in automotive and industrial applications. Capacitive Pressure Sensors: Capacitive sensors measure pressure by detecting changes in capacitance as a diaphragm flexes under pressure. They are known for their high accuracy and stability, making them suitable for precise measurements in applications like HVAC systems and medical devices. Optical Pressure Sensors: Optical sensors use the interference or absorption of light to measure pressure-induced deformations in a diaphragm. These sensors offer high accuracy and are used in specialized applications like aerospace and medical equipment. Resonant Pressure Sensors: Resonant sensors rely on the change in the resonant frequency of a diaphragm or resonator under pressure. These sensors are often used in applications where long-term stability and high accuracy are crucial, such as weather monitoring and precision instruments. Microelectromechanical Systems (MEMS) Pressure Sensors: MEMS pressure sensors are miniaturized devices that integrate various sensing elements into a single chip. They are widely used in consumer electronics, automotive, and mobile devices due to their compact size and cost-effectiveness. The choice of pressure sensor type depends on factors such as the required accuracy, range, environmental conditions, and cost constraints of a particular application. Selecting the right pressure sensor is crucial to ensure the reliable and precise measurement of pressure in a given system.

Referring to FIG. 2, and 7, the controller 80 may be connected to control operation of the freeze-drying operation based on data from the pressure sensor. For example, and as elaborated on below, pressure readings from the chamber 30 may be used for a variety of purposes, such as deciding when a freeze-drying operation is complete, or when a sufficient vacuum is reached to begin a heating phase, or when to initiate a stall phase. A suitable pressure sensor may be used, such as a capacitive pressure sensor, although other sensor types may be used.

Referring to FIGS. 1, 3, 6, and 7, the cooling system 42 may be connected to cool the vacuum chamber 30. The cooling system 42 may be mounted within an interior 24 of the housing 20, for example in a base part 31 of housing 20. One or more brackets (not shown) may secure the system 42 in place. The cooling system 42 may be connected to supply and return coolant to and from the vacuum chamber 30, for example via a coolant loop or coil. The coolant loop may comprise a coolant coil 51 that encircles the vacuum chamber 30. The coolant coil 51 may loop a plurality of times around the side walls 30C, top wall 33D, and base 33E of the chamber 30. The coolant used may be a suitable coolant, such as 449A™ refrigerant, also known as Freon, or another suitable refrigerant such as 404 or glycol. The cooling system 42 may comprise a condenser package, such as a ¼ horsepower unit, which may incorporate a compressor and a condenser. One or more heat sinks (not shown) may be provided. The cooling system 42 may send and return coolant to, for example around as shown, the vacuum chamber 30 to cool the contents of the vacuum chamber 30. Vents 88 in housing 20 may permit heat exchange with ambient air outside the housing 20. The cooling system 42 may mount within interior 24 of the housing 20 via a suitable fashion, such as one or more brackets (not shown). In the example shown, electrical insulating washers, such as nylon 6/6 sleeve washers 130, may be used to mount cooling system 42 to housing 20 in an electrically isolated manner. Nylon washers help mount the compressor off the case to prevent galvanic corrosion and rust, current condenser plate is iron, so if you put iron on stainless steel the iron will rust out. Referring to FIG. 7, an insulative shroud 29 may be wrapped around an exterior 38 of the vacuum chamber 30, for example around coil 51 to thermally insulate the chamber 30 for higher efficiency heating and cooling, and to reduce external condensation on coil 51. The coil 51 may comprise copper tubing or other thermally conductive materials. Insulation may be selected from suitable options, such as those made by Reflectex™, for example space grade shiny bubble wrap.

Referring to FIGS. 2-3 and 7, the apparatus 10 may comprise be configured to connect to a vacuum pump 62 that in use is connected to evacuate air from the vacuum chamber 30 via a vacuum line 61. The line 61 may extend from a port 77 in chamber 30. A venting system 46 may be provided on line 61 or adjacent port 77, and may include a vent actuator such as a release valve 47 that may be used to vent the contents of chamber 30, for example to release the vacuum and permit influx and pressurization of the contents of chamber 30. On the vacuum line, there may be a repressurization filter, for example a 5-micron filter that separates dust and debris as it is flowing into the system. Air repressurization may be part of the same procedure as the vacuum outlet, with a manual or automatic valve for releasing air. One suitable type of vacuum pump 62 is a NAVAC NP7DP™. Vacuum pumps may be used to remove air and other gases from enclosed spaces, creating a vacuum or low-pressure environment. These pumps play a critical role in processes such as chemical and pharmaceutical production, semiconductor manufacturing, and vacuum metallurgy. Vacuum pumps can be categorized into several types, including positive displacement pumps, such as rotary vane and piston pumps, and kinetic pumps like turbomolecular and diffusion pumps. Positive displacement pumps mechanically trap and exhaust gas molecules, making them suitable for achieving lower vacuum levels. Kinetic pumps, on the other hand, use high-speed rotors to transfer gas molecules from the inlet to the outlet, allowing them to reach higher vacuum levels. The choice of vacuum pump type depends on factors such as the desired vacuum level, gas composition, and application-specific requirements. Proper maintenance and selection of the right vacuum pump are essential for maintaining the integrity and efficiency of vacuum-dependent processes.

Various parts of a vacuum pump may include one or more of the following. Inlet Port: This is where the gas or air to be evacuated is introduced into the vacuum pump. It's often equipped with filters or screens to prevent foreign particles from entering the pump and causing damage. Pumping Mechanism: The heart of the vacuum pump, this component creates the necessary pressure differential to evacuate gas from the system. Different types of vacuum pumps use various mechanisms such as rotary vanes, pistons, turbomolecular rotors, or diaphragms to achieve this. Exhaust Port: This is where the pumped gas or air is expelled from the vacuum pump. It often includes an exhaust valve or muffler to control the release of gas and reduce noise. Oil Reservoir: In oil-sealed vacuum pumps, an oil reservoir is used to lubricate and seal the pump's moving parts. This oil also helps trap and remove contaminants from the pumped gas. Oil-free vacuum pumps do not have this component. Oil Mist Separator: In oil-sealed pumps, this component separates oil vapor from the exhaust gas, preventing oil contamination of the vacuumed gas. Cooling System: Some vacuum pumps require cooling to dissipate heat generated during operation. This can include fans, heat exchangers, or liquid cooling systems. Valves: Vacuum pumps often feature various valves, such as inlet and outlet valves, to control the flow of gas and maintain the desired vacuum level. Control System: Modern vacuum pumps may include electronic control systems that allow for precise monitoring and adjustment of vacuum levels, pressure, and other parameters. Safety Features: Safety components like pressure relief valves and sensors are often integrated into vacuum pumps to prevent over-pressurization or other potentially dangerous situations. The specific components and their complexity can vary widely depending on the type and application of the vacuum pump. Proper maintenance and understanding of these components are crucial for maintaining the pump's efficiency and ensuring the vacuum system's reliable operation.

Oil-water separators may be used in vacuum pump systems designed to remove oil and water vapor from the extracted gases or air. In vacuum applications, especially those involving oil-sealed rotary vane or piston pumps, the pump oil can become contaminated with water vapor and other condensable gases. This contamination can negatively impact the pump's performance and longevity. A suitable vacuum pump 62 may incorporate a filter or separator for removing undesirable materials or fluids from the expelled air. Oil-water separators function by allowing the extracted gas to pass through a series of coalescing or separation elements, which capture and separate oil and water droplets from the gas stream. These separators typically employ a combination of mechanical and chemical processes to efficiently remove the contaminants. Once separated, the oil and water are collected in distinct chambers or reservoirs for proper disposal or recycling, while the cleaned gas is then released into the vacuum system. By incorporating oil-water separators into vacuum pump setups, system efficiency and the life of the pump can be significantly extended while maintaining the quality of the vacuum environment.

Referring to FIGS. 1, 2, 5, and 7, the controller 80 may have suitable characteristics and may be structured to control the operation of the freeze-dryer apparatus 10. The controller 80 may comprise a processor 82, such as a printed circuit board 136. The controller 80 may be mounted in the top hat part 25, or another suitable point on or in housing 20. A suitable display, such as a display screen 90, for example a Kinco GO70™ seven-inch touchscreen display may be mounted to outer housing 20 to permit a user to one or more of view the status of the apparatus 10 and control operation of the apparatus 10. The screen 90 may act as an interface to permit a user to activate the controller 80. The programming of the apparatus 10 may be manipulated via screen 90. In other cases, the controller 80 may interface with an external computer, such as on a mobile phone via an app or website, or on an external desktop or laptop computer.

Referring to FIGS. 1, 2, 5, and 7, the controller 80 may be configured to operate a freeze-drying operation in a suitable fashion. The controller 80 may initiate in sequence, a vacuum freeze mode, followed by a heating phase. In the vacuum freeze mode, the mode may operate until air pressure is reduced in the vacuum chamber 30 to at or below a threshold pressure. In the heating phase, a supply of continuous and non-zero power may be provided to the variable power heater 140 and may be adjusted in real time by the controller 80 to maintain the food tray 70 at range of temperature, for example at a rate of temperature increase. The heating phase may comprise a first heating phase and a second heating phase. In the second heating phase the supply of continuous and non-zero power to the variable power heater may be adjusted to maintain the food tray 70 at a second rate of temperature increase that is higher than a first rate of temperature increase used with the first heating phase. The second phase may be tailored and used as a mechanism to pull the last amounts of water out of a partially freeze-dried food product. Typically, the last remnants of water are the most difficult to remove, and hence may be assisted by additional temperature to assist the process. The controller 80 may be configured to initiate a stall phase during one or both the first heating phase or the second heating phase when a pressure within the vacuum chamber remains above a low-pressure threshold for more than a predetermined amount of time. The controller may be configured to operate the stall phase by: shutting off power to the variable power heater; and returning to the first heating phase or second heating phase when a pressure within the vacuum chamber drops below the low-pressure threshold. The stall phase is a failsafe in case the product doesn't continue to sublimate at the desired rate or it overpressures. The stall creates a timer to move system along to prevent it from staying at one cycle forever, or it will enter stall when heat goes too high cutting power allowing the system to regain control. The stall phase is not a regular operating mode-it might happen depending on the product being freeze dried, as every product has different content, and it depends on how much material is in the freeze dryer.

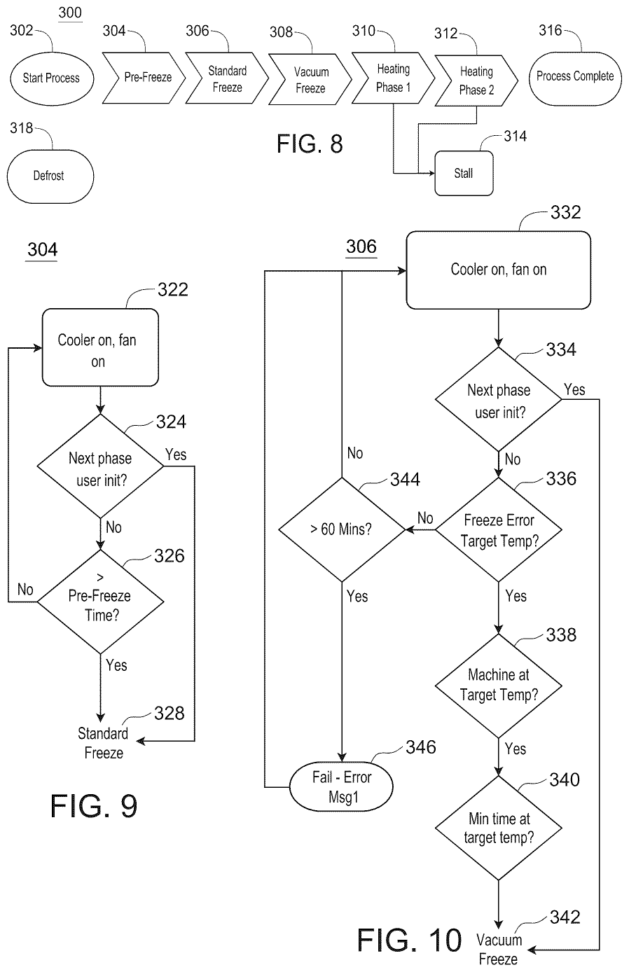

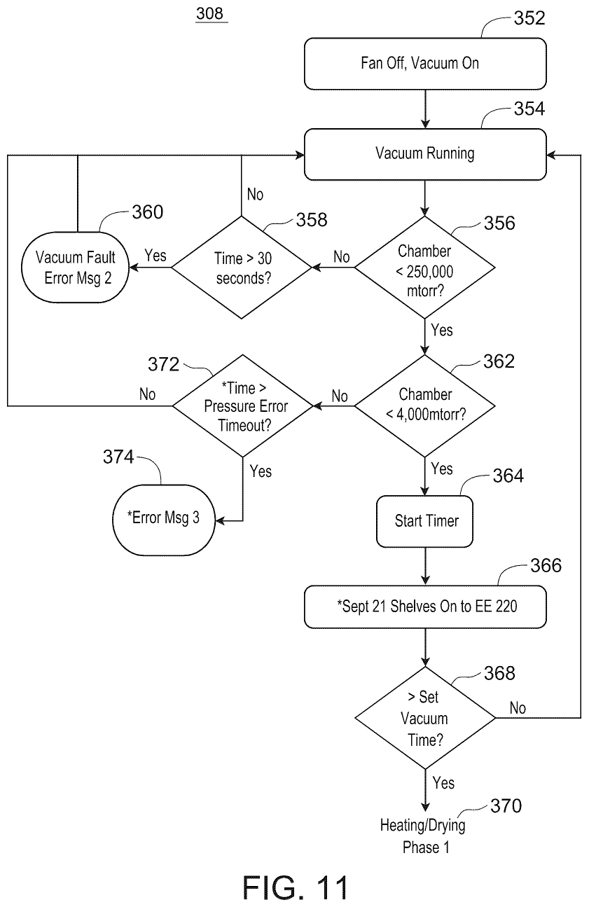

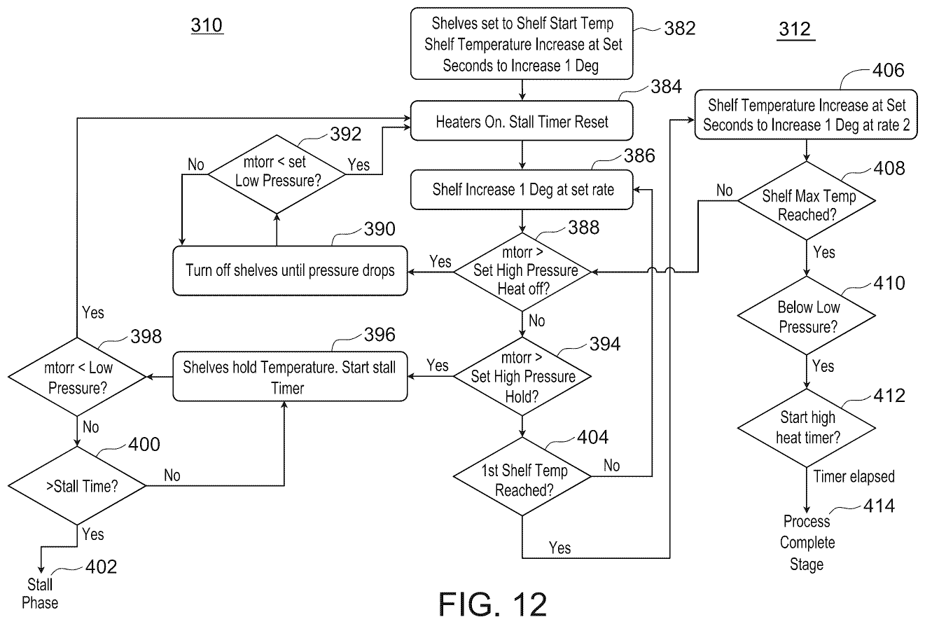

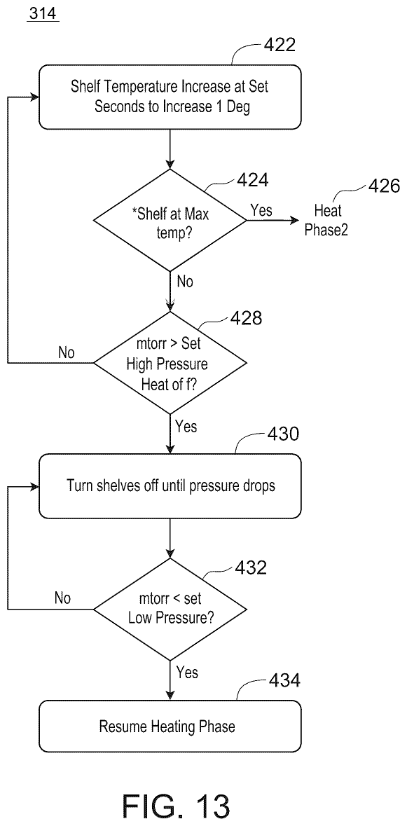

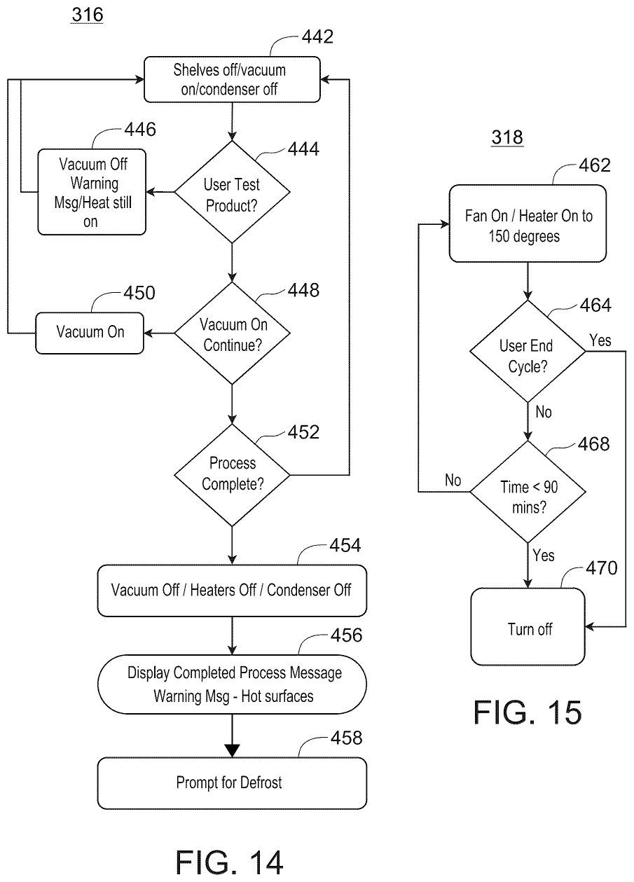

Referring to FIGS. 8-15, various methods of freeze-drying are disclosed. Referring to FIG. 8, an example overall flow process 300 of a freeze-drying operation is illustrated. In the field, an actual apparatus 10 may operate with some or all of the stated steps in FIG. 8. In step 302, the process is initiated, for example by a user pressing a command start button on the apparatus 10. In a step 304, a pre-freeze phase may be carried out to pre-freeze the chamber 30. In a step 306, food 21 is added to the vacuum chamber 30 via trays 70, and a standard freeze phase is carried out to freeze the trays 70 and contents thereon. Cooling may comprise blast chilling an interior 36 of the vacuum chamber 30, for example using fan 126. In a step 308, the vacuum pump 62 is initiated and a vacuum freeze phase is carried out to continue to cool the food 21 under vacuum. In a step 310, a heating phase is carried out, in this case a first heating phase. In a stage 312, a second heating phase is carried out. At any point in the heating phases, a stall phase may be initiated as a step 314 depending on various conditions existing. In a step 316, the process may be completed, and a defrost or other cycle may be run.

Referring to FIGS. 1-7 and FIG. 9, a process for a pre-freeze mode (step 304) is illustrated. In a process step 322, the door 27 is closed and locked, and the cooling system 42 is activated with fan 126 on. This step will cool the chamber 30 to prepare it for freeze-drying. In a decision step 324, the system may request user input if the settings of the program being run require same. For example, user input may be required if the process is being run in a manual control mode. If yes, then the system may remain in the pre-freeze mode indefinitely until the user provides the requested input. If not, in a decision step 326 the system compares the elapsed time of the pre-freeze mode with a pre-freeze run time threshold, and if the actual time run is less, the process recycles, until the actual run time has equaled or eclipsed the pre-freeze run time setting. Once the time has elapsed, the system moves to a standard freeze phase 328. If in step 324 user input is required to advance the process, the user may be prompted to provide input. In some cases, the input required is that the user confirm that food 21 has been added to chamber 30.

Referring to FIGS. 1-7 and 10, a process of a standard freezing mode or phase (step 306) is illustrated. In a process step 332, the system confirms that the cooling system 42 is on, and fan 126 is on to cool the contents of the vacuum chamber 30, which include food 21 on one or more food trays 70. In a decision step 334, the system queries its programming to see whether the next phase requires user input. If yes, the system may continue the freeze mode until the user provides the requested input to advance to the next phase. If no, the system may run a series of checks to determine whether it is suitable to advance to the next process. In a decision step 336, the system may check whether the freeze error target temperature has been reached. If not, the system may in a decision step 344 check whether the elapsed time is greater than 60 minutes. If yes, the system may fail out in a process step 346, with an error message. If not, the system may recycle back to process step 332. If the target temp is reached, in a decision step 338 the system checks whether the chamber 30 is at its respective target temperature. If yes, the system in a decision step 340 asks whether its minimum time at the target temperature has elapsed, and if so, the system enters the vacuum freeze mode in process step 342.

Referring to FIGS. 1-7 and 11, a process of a vacuum freeze phase (step 308) is illustrated. In a process step 352, the system ensures the fan 126 is on, and the vacuum pump 62 is on. In a process step 3545, the system ensures the vacuum pump 62 is running. In a decision step 354, the system checks whether the chamber 30 is at less than 250,000 mtorr pressure. If no the system in a decision step 358 checks whether the elapsed time is greater than 30 seconds. If yes, the system fails out and sends an error message in a process step 360. If no, the system recycles back to step 354. If yes in step 356, the system then checks whether the pressure in chamber 30 is less than 4,000 mtorr. If no, the system in a decision step 372 checks whether the time elapsed is greater than a pressure error timeout threshold, and if yes, the system sends an error message in a process step 374, failing out. Otherwise, the system recycles back to step 354. If yes in step 362, the system starts a timer in process step 364. In a process step 366, the system turns the shelves on to EE 220. In a decision step 368, the system checks whether the timer is greater than a set vacuum time threshold, and if no, the system recycles back to step 354. If yes, the system moves to a heating and drying phase in process step 370.

Referring to FIGS. 1-7 and 12, a process of a heating phase (steps 310 and 312) is illustrated. In a first heating phase, in a process step 382, the system sets each shelf (tray 70) to its shelf start temperature, and sets each shelf to its temperature increase at set seconds to increase 1 degree. In a process step 384, the system turns the heaters 140 on in each tray 70, and resets a stall timer. In a process step 386, the system checks whether the pressure is greater than a set high pressure heat off threshold. If yes, the system in a process step 390 turns off the trays 70 until the pressure drops. This threshold may be set high enough that the system would not normally initiate this step unless in an unusual situation as it is not ideal to turn the heaters 140 fully off although it may be required in some cases to avoid damaging the food 21. In a decision step 392, the system checks whether the pressure in chamber 30 is less than a set low pressure threshold, and if yes, the system returns to step 384. If no, the system returns to step 390. If no in step 388, the system checks in decision step 394 whether the pressure is greater than a set high pressure hold threshold. If yes, the system in a process step 396 sets the trays 70 to hold temperature, and starts a stall timer, as the arrival at this point in the process may mean that the stall phase may need to be initiated. The system in a decision step 398 then asks whether the pressure is less than a low-pressure threshold, and if yes, returns to step 384. If no, the system in a decision step 400 checks whether the stall timer is greater than a stall time threshold, and if yes proceeds in process step 402 to a stall phase. If no, the system returns to step 396. If no in step 394, the system in a decision step 404 checks whether the trays 70 have achieved their first temperature threshold. If no, the process returns to step 386. If yes, the system advances to the second heating phase in process step 406. The tray temperature increase at set seconds to increase 1 degree is thus set. In a decision step 408, the system checks whether the tray maximum temperature is reached, and if no returns to step 388. If yes, the system in a decision step 410 checks whether the pressure is below the low-pressure threshold. If yes, the system in a decision step 412 starts a high heat timer. Once the timer has elapsed, the system moves to process step 414 to a process complete phase.

Referring to FIGS. 1-7 and 13, a process of stall phase (step 314) is illustrated. In a process step 422, the system sets the tray 70 temperature increase at set seconds to increase 1 degree to its programmed rate. It should be noted that all temperature increase rates can be set to any suitable values as requested, and do not have to be in increments of seconds per 1 degree temperature increase. In a decision step 424, the system checks whether the tray is at its maximum temperature. If yes, that tray 70 returns in process step 426 to the respective heat phase for that tray that was left to enter the stall phase. If no, the system in a decision step 428 checks whether the pressure is greater than a set high pressure heat of fusion. If no, the system returns to step 422. If yes, the system in a process step 430 turns off the tray 70 until the pressure drops. In a decision step 432, the system checks whether the pressure is less than a set low pressure threshold. If no, the system returns to step 430. If yes, the system ion a process step 434 goes to a resume heating phase.

Referring to FIGS. 1-7 and 14, a process of a process complete phase (step 316) is illustrated. In a process step 442, the system turns the heaters 140 of the trays 70 off, and turns the vacuum pump 62 and cooling system 42 off. In a decision step 444, the system checks whether the user wants to test the product. If yes, in a process step 446, the system provides a vacuum off heat warning, and returns to process step 442 after the product is tested. If no in step 444, the system checks in a decision step 448 whether the user wants the vacuum to continue running, for example if the user determines that the food product needs more freeze drying after inspection. If yes, the system in a process step 450 turns on the vacuum pump 62 and returns to step 442. If no in step 448, the system in a decision step 452 asks the user to confirm whether the process is complete. If no, the system returns to step 442. If yes, the system in a process step 454 turns the vacuum pump 62 off, the heaters 140 off, and the cooling system 42 off. In a process step 456, the system displays a completed process message and a hot surfaces warning. In a process step 458 the system prompts the user to initiate a defrost phase.

Referring to FIGS. 1-7 and 15, a process of a defrost phase (step 318) is illustrated. In a process step 462, the system turns the fan is on and puts an internal heater on to 150 degrees (not the heaters 140). In a decision step 464 the system checks whether the system has reached a user-entered end cycle time. If yes, the system in a process step 470 turns off. If no in step 464, either because the time has not elapsed, or because no end cycle threshold was entered by the user, the system in a decision step 468 checks whether the elapsed defrost time is less than 90 minutes. If no, the system returns to step 462. If yes, the system in a process step 470 turns the apparatus 10 off.

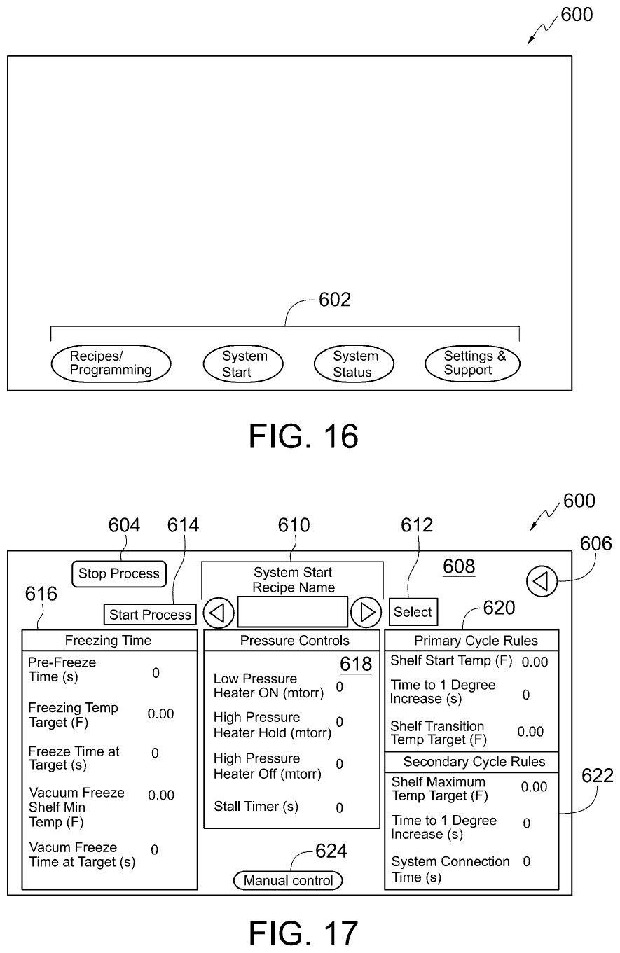

Referring to FIGS. 16-25, various screenshots of an example user interface 600 (UI) are shown for operating the apparatus 10. The UI may be displayed in display 90 in FIG. 1. Referring to FIG. 16, a start screen is illustrated, where a user can select from buttons 602 whether to edit recipes, start the system, check system status, or check settings & support.

Referring to FIG. 17, if the system start button is pressed, the system displays a system start screen. In a header field 610, on the screen 608, the system displays the name of the screen. A stop process button 604 may be pressed at any time to stop the operation. A start process button 614 may be entered to start a process. Select buttons 612 may be used to select different inputs to modify. A button 606 may be used to go back in the process to the last screen. In a field 616, various parameters for freezing phases are illustrated. In a field 618, various parameters for pressure controls are shown. In a field 620, various primary cycle rules controls are illustrated, and in a field 622, various secondary cycle rules are illustrated. A manual control button 624 may be pressed to enter manual control mode at any time.

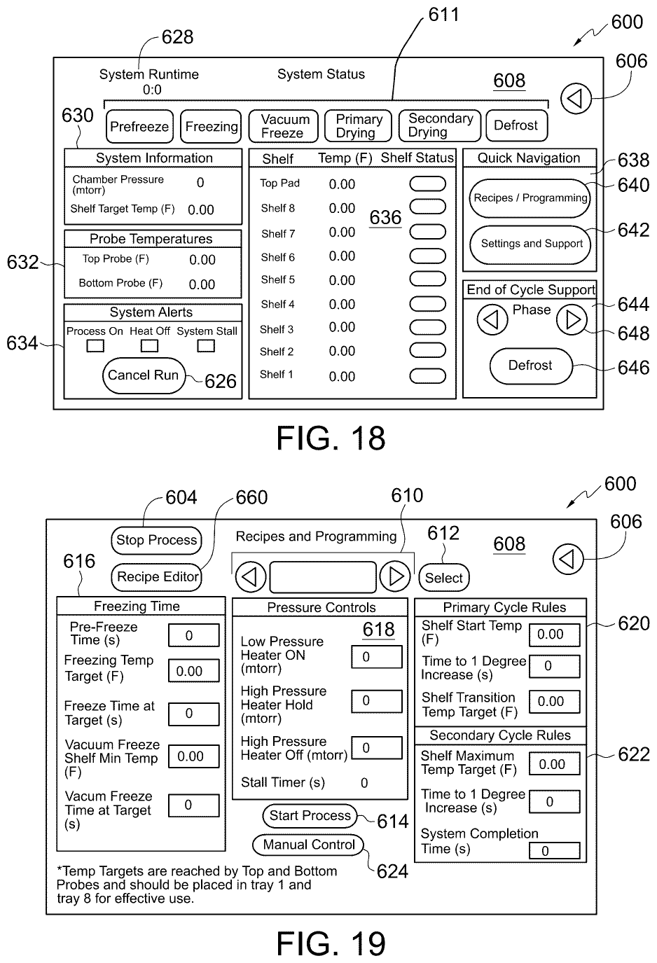

Referring to FIG. 18, if the system status buttons is pressed, the system display a system status page on screen 608. Lights may be provided to indicate if the process is running, heat is off, and system stalled. Shelf status indicators may turn green when the shelf is on. Phases can be skipped on the bottom right when the process is running. Defrost can be run from this screen from the bottom right. Buttons for the Recipes and Programming Screen and Settings and Support screen can be found on the right. An elapsed system run time may be displayed in field 628. back button 606 may be used to go back to the last screen. Various buttons may be selected in area 611 to select different phases of the process, or the area 611 may be used to indicate only the name of the phase the process is currently in. In a field 630, the system displays various system information. In a field 632, the system displays various probe temperature information. In a field 634, the system displays any alerts, and provides a button 626 for a user to cancel the run. In a field 636 the system displays settings and data from each tray 70. In a field 638, the system displays quick navigation options, including a button 640 to go to a recipes/programming page, and a button 642 to go to a settings and support page. In a field 644, various end of cycle support options are shown, included buttons 648 to advance or retreat to various phases in the process, and a button 646 is provided to proceed to defrost if desired.

Referring to FIG. 19, if the recipes and programming button is pressed, the system displays the recipes and programming page on screen 608. The system (such as controller 80) may be configured to store or access a database of freeze-drying operation recipes. The system may be configured to display an edit-recipe user interface as shown configured to allow a user to edit existing recipes and create novel recipes. Such recipes, once edited, may be stored by the system in the database for future use in a freeze-drying operation to be carried out by the freeze-dryer apparatus. A button for the Recipe Editor is found here. Recipes can be selected and started from this screen. All values can be entered manually as well. Button for the Manual Control screen is at the bottom. A back button 606 is provided to go back to the previous page. Navigation buttons 612 and the other buttons in field 610 are provided, including a field for a name of a recipe if selected. Buttons 604 and 660 may be provided to stop the process or edit recipes, respectively. In a field 616, freezing information is provided for a recipe. In a field 618 various pressure controls are provided. In fields 620 and 622 various cycle rules are provided. Buttons 614 and 624 are provided to allow the user to start the process or enter manual control mode.

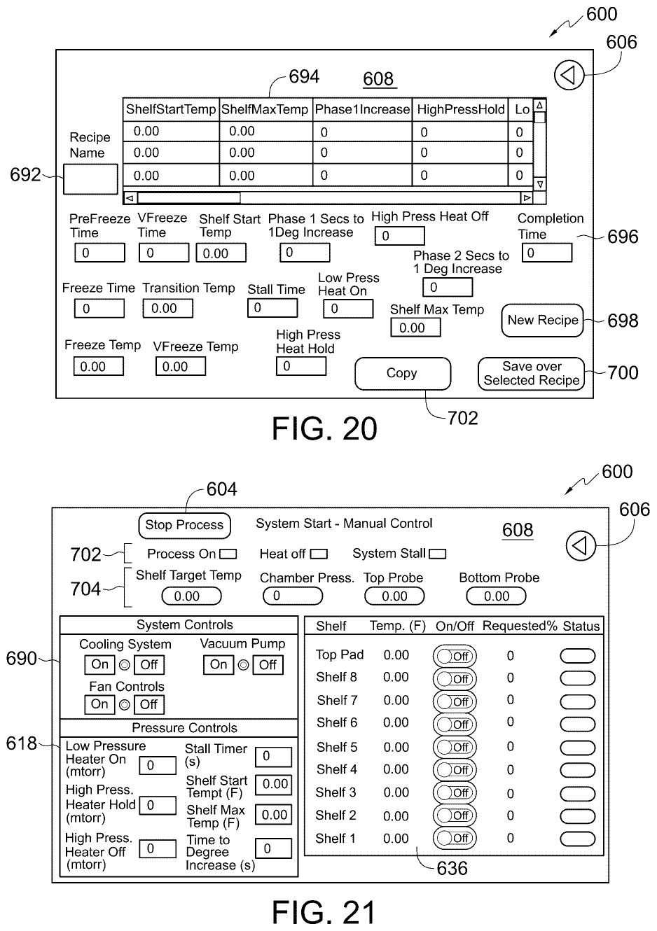

Referring to FIG. 20, a detailed recipe edit page is provided on screen 608. Button 660 permits the user to return to the previous page. Recipes can be made and saved from this screen. A recipe may be highlighted in the spreadsheet, the copy button pressed and the values will appear in the boxes below. If changes are made, the user can save over the selected recipe. The user may select a new recipe instead and save over that recipe. In a field 694, a table of detailed data parameter entry is provided for precise control of a recipe. In a field 692 the recipe name may be provided and edited. In a field 696 detailed data entry for a recipe can be entered and reviewed. Buttons 698, 700, and 702 are provided for various controls.

Referring to FIG. 21, a manual control page is provided on screen 608. The Manual Control screen allows the user to turn the cooling system on or off, the fan on or off, and the vacuum on and off. Values for the controls are entered here. Shelves may be turned on and off from here as well. The status indicators will turn green when the shelf is on. Buttons 604 and 606 are provided. Status indicators 702 and 704 are provided to display information based on the present run. In a field 690, various system controls are provided for the user to modify if desired. In a field 618, various pressure controls may be adjusted. In a field 636, tray information is provided and can be edited in real-time.

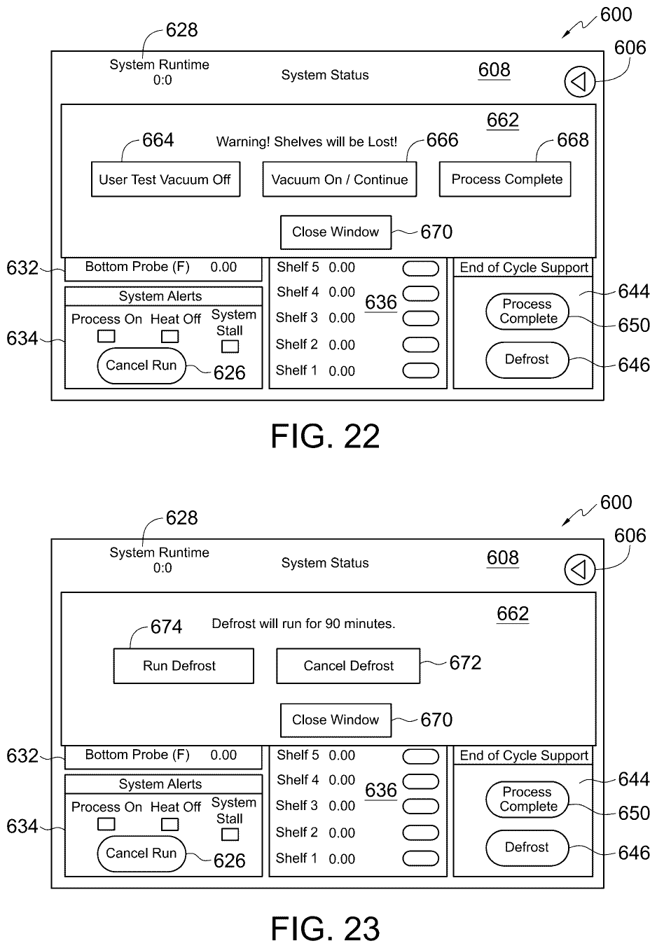

Referring to FIG. 22, a system status page is illustrated on screen 608 with a warning pop-up. Pressing the process complete button will give the user the option to turn the vacuum off for testing, then turn it back on if the user wants it to continue. If the user is happy with the product, they may select process complete. Timer field 628 and button 606 are provided as before. In a field 662, a pop-up alert is illustrated overlaid the previous page, to indicate a warning to a user that trays 70 will be lost if the process continues. A button 665 allows the user to test the food and turn off the vacuum accordingly. A button 666 allows the system to turn the vacuum on and continue the process. A button 668 allows the process to be complete. A button 670 closes the pop-up window.

Referring to FIG. 23, a system status page is illustrated on screen 608 with a further warning pop-up in field 662. Pressing Defrost will prompt the user to run defrost. Defrost will run for 90 minutes unless canceled. The pop-up indicates that defrost is about to occur if approved. A button 674 allows a user to initiate defrost. A button 672 allows a user to cancel defrost. A button 670 allows the user to close the pop-up window.

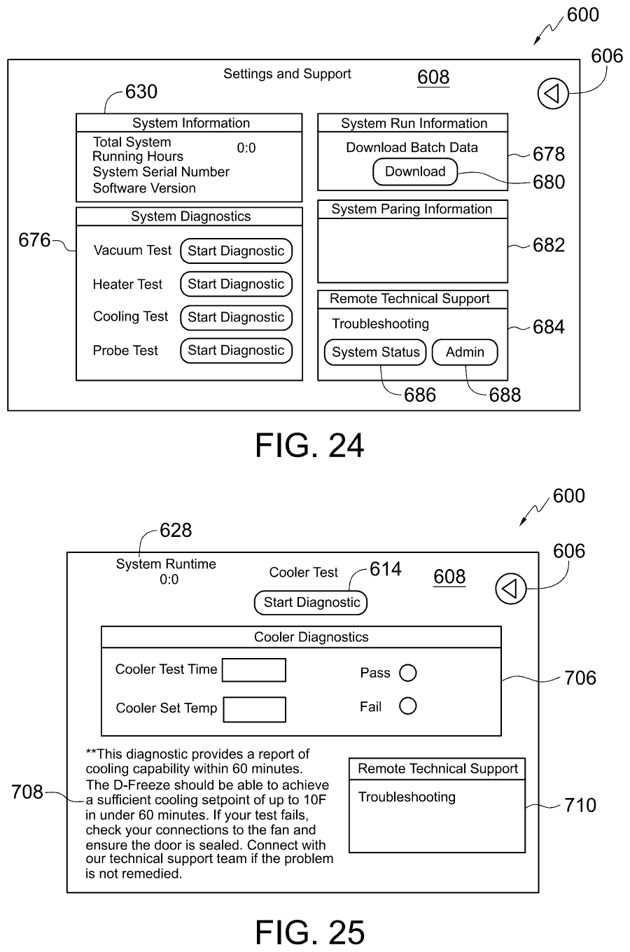

Referring to FIG. 24, if the settings and support button is pressed, a settings and support page appears on screen 608. Button 606 is provided as before. In a field 630, various information on the system is illustrated. In a field 676 various diagnostics may be selected and run to troubleshoot an issue. In a field 678 a user can press button 680 to download run data. In a field 682 various pairing information is provided, for example to indicate what Bluetooth devices are connected to the system. In a field 684 a technical support field is shown, with buttons 686 and 688 to check status and contact an administrator.

Referring to FIG. 25, a diagnostic page is shown on screen 608. A timer field 628 and button 606 are provided as before. A button 614 may be used to initiate a diagnostic. In a field 706 a user may set various parameters for a diagnostic. In a field 708 a text of information is provided for the user. In a field 710, options to connect with remote technical support are provided, for example a chat help screen.

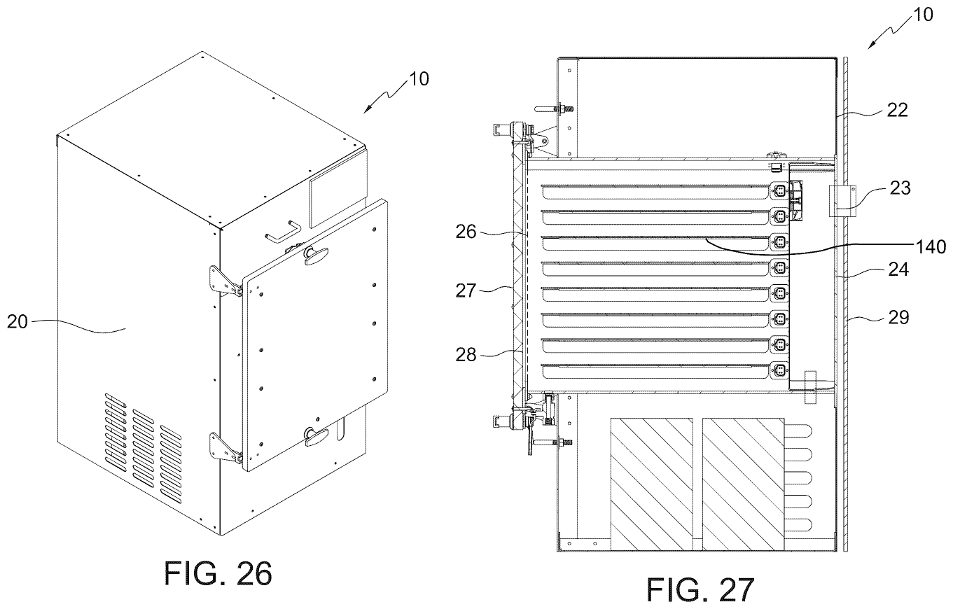

Referring to FIGS. 26-31, a further embodiment of the present apparatus 10 may be used to freeze dry material (not shown). It will be appreciated that the material may be any material desirous to be freeze-dried, including food and components for manufacturing. Advantageously, as will be appreciated, apparatus 10 may be used to freeze-dry thermosensitive, delicate, or harmful materials that may not be freeze-dried using known apparatuses and methods. Apparatus 10 may comprise housing 20 for housing the elements of apparatus 10. Referring to FIG. 27, housing 20 may have a top, a bottom, and four sides formed by sidewall 22, wherein sidewall 22 comprises exterior surface 23, interior 24, and aperture 26 through which the material may be inserted or removed from apparatus 10. Sidewall 22 may be made of a vacuum-resistant material including stainless steel, ceramic, or any other material or combination of materials that are known to be suitable. In some embodiments, aperture 26 may be reversibly sealed by hinged door 27 in sealing contact with seal 28. Although the present embodiments contemplate reversibly sealing aperture 26 using a hinged door and seal, other means of reversibly sealing aperture 26 are known and may be substituted.

In some embodiments, housing 20 may be insulated by insulator shroud 29. As will be appreciated, shroud 29 may insulate housing 20 from exterior temperature conditions that may be unsuitable for freeze-drying. Shroud 29 may be formed of any known insulating material including closed-cell and open-cell insulating polymers or an insulating chamber comprising a medium such as insulating fluids, air, or some other material, or a vacuum. Insulator shroud 29 may be positioned adjacent to exterior surface 23 of sidewall 22, either in direct contact with exterior surface 23 or positioned away from exterior surface 23 with another medium, such as insulating fluids, air, or some other material, or a vacuum disposed therebetween. In some embodiments, insulator shroud 29 insulates a desired portion of housing 20, such portion being appreciated by a person of skill in the art. In other embodiments, insulator shroud 29 insulates substantially all of housing 20. Other configurations of insulator shroud 29 will be appreciated.

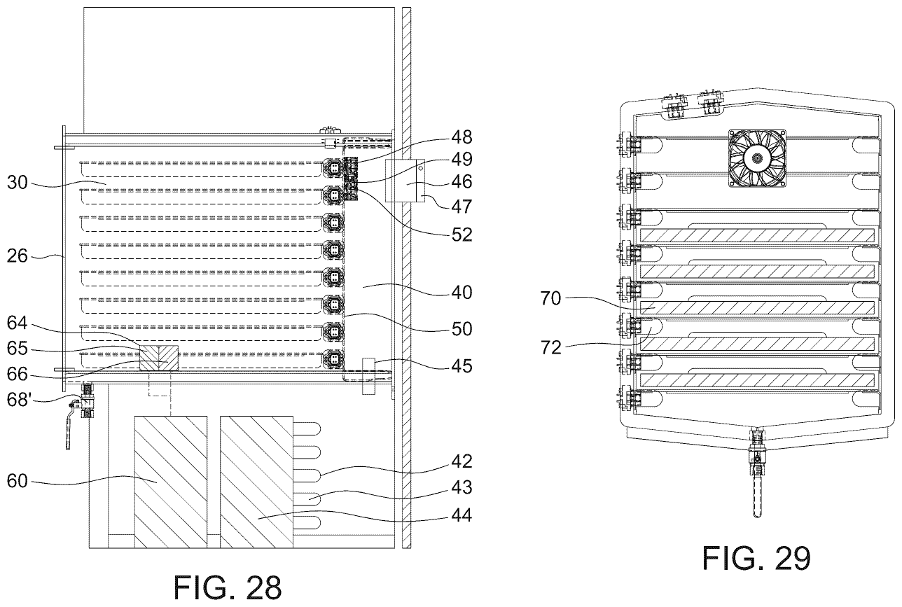

Referring to FIG. 28, housing 20 may form freeze-drying chamber 30 for freeze-drying the material. Freeze-drying chamber 30 may have an interior volume and geometry suitable to receive at least between 20 to 25 lbs. of the material; however, it will be appreciated that freeze-drying chamber 30 may have any suitable geometry or volume for receiving material to be freeze-dried.

Referring to FIGS. 27-28, the vacuum chamber 30 may define a condenser chamber and a tray chamber separated from one another by a partition. In some embodiments, housing 20 may form condenser chamber 40 for sequestering and condensing water vapour removed from the material during freeze-drying. Condenser chamber 40 and freeze-drying chamber 30 may be partitioned by partition 50. Partition 50 may enhance sequestration of water vapour within condenser chamber 40 and prevent condensed, liquid water from draining from condenser chamber 40 into freeze-drying chamber 30. In preferred embodiments, partition 50 may be a substantially vertical interior wall within housing 20 such that condenser chamber 40 and freeze-drying chamber 30 are disposed side-by-side within housing 20. In such embodiments, partition 50 may be positioned so that condenser chamber 40 is located opposite of aperture 26 and freeze-drying chamber 30 is located adjacent aperture 26, such that material may be inserted or removed directly from freeze-drying chamber via aperture 26. In other embodiments, partition 50 may be horizontally-disposed such that condenser chamber 40 and freeze-drying chamber 30 are positioned vertically within housing 20 (e.g., condenser chamber 40 may be positioned underneath freeze-drying chamber 30). As will be appreciated, the vertical or horizontal disposition of partition 50 will impact heat distribution and fluid distribution within the body and may be selected accordingly. In some embodiments, partition 50 may be a baffle forming fluid channel 52 between condenser chamber 40 and freeze-drying chamber 30 or, alternatively, may comprise at least one aperture or other known means for permitting fluid (i.e., air and water vapour) to move between condenser chamber 40 and freeze-drying chamber 30.

In some embodiments, condenser chamber 40 may comprise refrigeration system 42, drainage system 45, venting system 46, and forced air system 48. As will be described in more detail, below, refrigeration system 42, drainage system 45, venting system 46, and forced air system 48 may be operable to freeze the material to be freeze-dried and remove water vapour from within housing 20.

In some embodiments, refrigeration system 42 may comprise condenser coils 43 and compressor 44 for reducing the temperature within condenser chamber 40 and causing water vapour to condense into liquid water or ice. A known refrigerant may be disposed within refrigeration system 42 for facilitating heat transfer from condenser chamber 40 to the external environment. Condenser coils 43 may be positioned within condenser chamber 40 in fluid connection with compressor 44. Although compressor 44 is shown positioned below condenser chamber 40, it will be appreciated that compressor 44 may be positioned elsewhere. It will also be appreciated that the configuration (i.e., length, diameter, coil geometry, etc.) and placement of condenser coils 43 may be varied from the embodiments disclosed herein. For example, multiple sets of condenser coils in thermal communication with each other may be used. Advantageously, however, the present apparatus 10 may comprise only one condenser coil 43.

In some embodiments, drainage system 45 may comprise a drainage valve. The drainage valve may be positioned at the lowermost portion of sidewall 22 within condenser chamber 40 to permit gravity-assisted drainage of liquid water from condenser chamber 40. In some embodiments, the drainage valve may be gravity-assisted or may comprise a pump. In preferred embodiments, the drainage valve may be configured to drain liquid water without releasing vacuum.

In some embodiments, venting system 46 may comprise actuated vent/valve 47. Actuated valve 47 may be configured to vent air and water vapour from within condenser chamber 40 without releasing vacuum.

In some embodiments, forced air system 48 may comprise fan 49 mounted in partition 50. Fan 49 may be operable to draw air and water vapor from freeze-drying chamber 30 into condenser chamber 40. As will be appreciated, forced air system 48 may be used to ensure consistent pressure and temperature conditions within freeze-drying chamber 30 during both freeze-drying of the material and freezing of the material prior to freeze-drying.

According to embodiments, apparatus 10 may comprise vacuum system 60 for evacuating air and water vapor from housing 20. In some embodiments, vacuum system 60 may comprise vacuum pump 62, pressure sensors 64, and filtered repressurization valve 68. As will be described in more detail, below, vacuum pump 62 may be operable to create a vacuum within housing 20, pressure sensors 64 may be operable to measure pressure within housing 20 for the purpose of controlling the operation of vacuum pump 62, and filtered repressurization valve 68 may be operable to release vacuum after the freeze-drying process is complete.

In some embodiments, pump 62 may be in fluid communication with freeze-drying chamber 30 and valve 68, wherein valve 68 permits air and water vapour collected by pump 62 to be expelled into the external environment. Although pump 62 is shown in FIG. 3. positioned below freeze-drying chamber 30, it will be appreciated that pump 62 may be positioned elsewhere within or external to apparatus 10. Similarly, valve 68 may be positioned at various positions across housing 20.

In some embodiments, pressure sensors 64 may comprise capacitance manometer 65 and Pirani gauge 66. It will be appreciated that the combination of capacitance manometer 65 and Pirani gauge 66 may be operable to detect when the solid and gaseous phases of water molecules within the material to be freeze-dried have reached equilibrium at a particular temperature (i.e., when sublimation has stopped at a particular temperature). Although pressure sensors 64 are contemplated to comprise capacitance manometer 65 and Pirani gauge 66, other combinations of different sensors are known to detect when sublimation has stopped at a particular temperature and may be substituted. For example, a sensor suite comprising a weight sensor for measuring the weight of the material may be used. As a further example, in preferred embodiments, pressure sensors 64 may comprise at least one 531 thermocouple gauge tube for measuring pressure within housing 20. In such embodiments, equilibrium between the solid and gaseous phases of water molecules within the material to be freeze-dried may be detected when the at least one 531 thermocouple gauge tube measures a stable pressure within housing 20 over a certain period of time at a certain temperature (i.e., the pressure does not change significantly). It will be appreciated that the requisite pressure measurement and period of time are factors that depend both on the material being freeze-dried as well as the temperature at which the measurements are being taken.

In some embodiments, filtered repressurization valve 68 may comprise a valve and a filter. In preferred embodiments, the filter may be suitable for removing contaminants such as bacteria and viruses from air that is allowed to flow through the valve into the present apparatus 10, such as a HEPA filter.

Referring to FIG. 29, apparatus 10 may comprise variable-current heater trays 70 and tray mounting means 72.

In some embodiments, tray mounting means 72 may be formed by opposite pairs of protrusions extending inwardly from interior surface of sidewall 22 within freeze-drying chamber 30. A plurality of tray mounting means 72 may be formed at different heights within freeze-drying chamber 30 to permit a plurality of trays 70 to be mounted within freeze-drying chamber 30. In some embodiments, tray mounting means 72 may be formed at such heights to permit airflow between the plurality of trays 70.

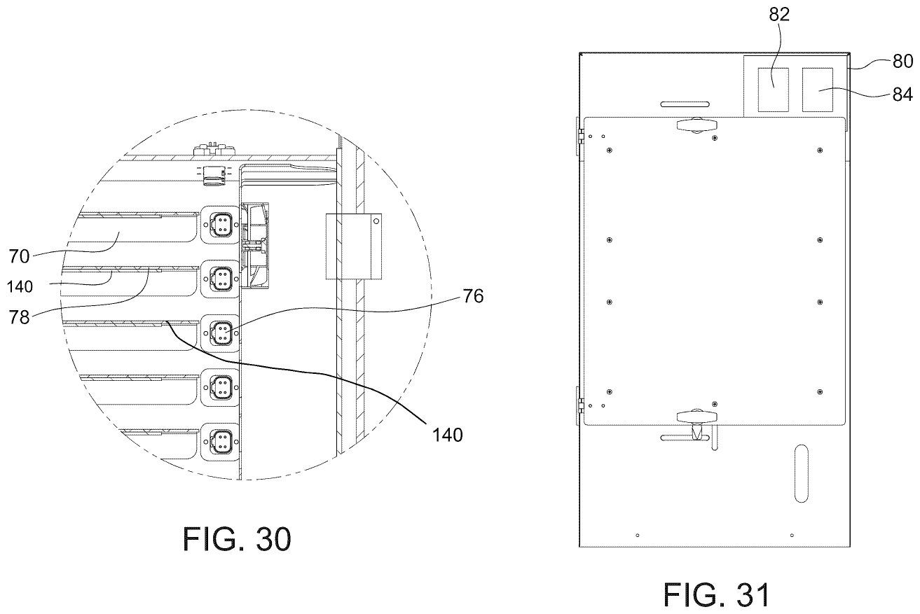

Referring to FIG. 30, heater trays 70 may comprise variable current heater 140, current controlling means 76, and temperature sensor 78. The controller 80 may thus sense the temperature of the tray or trays 70 using each respective sensor 78, and may adjust the continuous non-zero power to maintain the predetermined range of temperature. In operation, as will be described in more detail, below, variable current heater 140 may receive current from a power source (not shown) to increase the temperature of heater tray 70, current controlling means 76 may vary the current received by heater 140 to control the temperature of heater tray 70 with a high degree of precision, and temperature sensor 78 may measure the temperature of heater tray 70 so that current controlling means 76 may be operated as desired or programed. Advantageously, heater trays 70 may be operated independently, for example if different materials are received by different heater trays 70 or if conditions within freeze-drying chamber 30 result in a temperature differential across different heater trays 70 that requires compensation by one or more heater tray 70.

In some embodiments, temperature sensor 78 may be a polytetrafluoroethylene (PFTE) insulated thermocouple embedded within heater tray 70. As will be appreciated, any suitable temperature sensor may be used for measuring the temperature of heater tray 70.

According to embodiments, Referring to FIG. 31, apparatus 10 may comprise controller 80 for permitting an operator to control and/or program apparatus 10.

In some embodiments, controller 80 may comprise processor 82. It will be appreciated that processor 82 may be configured to receive and process signals from controller 80, pressure sensors 64, temperature sensor 78, and external devices such as a personal computer, smartphone, tablet, or remote operated by the operator (not shown), according to a pre-programmed freeze-drying recipe or other programming by the operator or a machine learning (AI) system. In some embodiments, controller 80 may be operable to receive feedback from

In some embodiments, controller 80 may comprise wireless system 84. Wireless system 84 may be configured to use any known wireless communication system, such as Wi-Fi, Bluetooth, etc., to wirelessly propagate signals between controller 80 and another device such as pressure sensors 64, temperature sensor 78, or external devices such as a personal computer, smartphone, tablet, or remote operated by the operator (not shown).

As an example of how controller 80 may operate, the present apparatus may include a recipe module accessing a remote recipe database that comprises one or more recipe instructions, and downloading a downloaded recipe instruction to a local memory of the apparatus. A user-input module receives a user-specified freeze-drying instruction. A freeze-drying module manages one or more mechanisms in the apparatus according to the downloaded recipe instruction and the user-specified freeze-drying instruction. A personalization module obtains a personalized recipe from a user of the apparatus and uploading the personalized recipe to a remote recipe database. A machine learning (AI) module records user entered recipe instructions and automatically calculates freeze-drying parameters and constitutes both into a complete recipe to be uploaded to the remote recipe database or apparatus. Optionally, the user-specified freeze-drying instructions can include a modification of the downloaded recipe. The modification of the downloaded recipe is uploaded by the personalization module to the remote recipe database. It will be appreciated that controller 80 may operate otherwise.

Embodiments of improved methods of use of the present apparatus are also provided herein. Generally, such methods may be used to freeze-dry material as disclosed above. In some embodiments, the present methods may comprise providing material to be freeze-dried, providing an apparatus having a vacuum pump and variable current heater trays for receiving the material, freezing the material, creating a vacuum, progressively increasing the heater tray temperature without causing temperature cycling, deactivating the tray heater, repressurizing the apparatus, and removing the freeze-dried material.

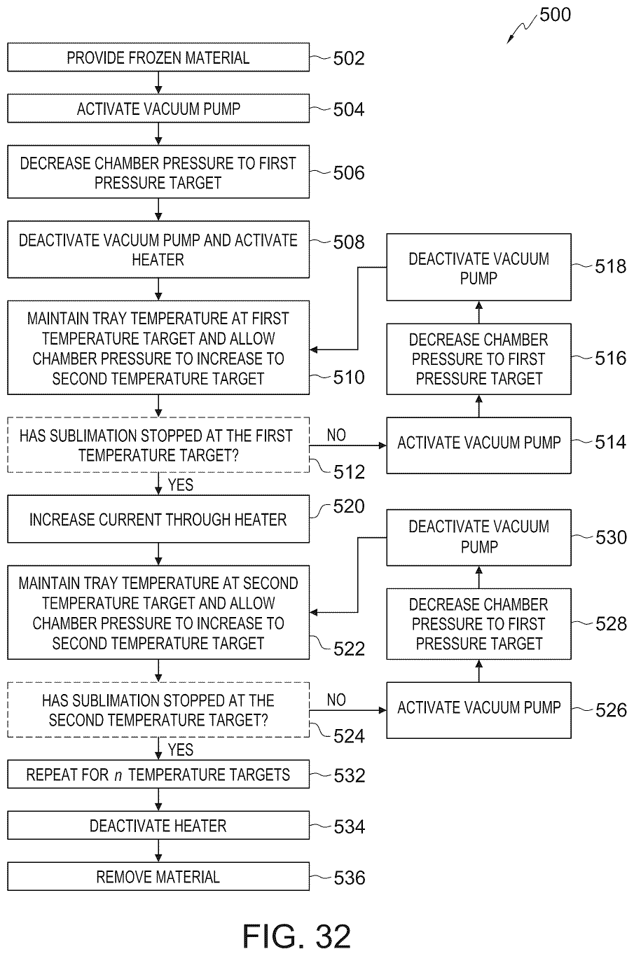

According to embodiments, Referring to FIG. 32, the present methods of use may enable non-cyclical, progressively increasing material temperatures during freeze-drying. In some embodiments, material to be freeze-dried may be provided pre-frozen or may be frozen within the apparatus. Methods of pre-freezing material are known and any suitable method may be used. Conversely, material to be freeze-dried may be provided unfrozen (i.e., substantially room temperature or any other temperature greater than the desired temperature following freezing), as will be appreciated.

In some embodiments, providing an apparatus having a vacuum pump and variable current heater trays for receiving the material to be freeze-dried may comprise providing the apparatus disclosed above.

In some embodiments wherein material is not provided pre-frozen (i.e., unfrozen material), freezing the material may comprise positioning the material on an appropriate heater tray within the apparatus and provide a means for freezing the material (i.e., a refrigeration system and, advantageously, a forced air system for circulating refrigerated air around the material). The operator may activate the refrigeration system and, optionally, the forced air system to reduce the material temperature below the freezing point for water (273.16 Kelvin at 101,325 Pascals). Advantageously, the material may be frozen rapidly (i.e., blast cooled, flash frozen, snap frozen, etc.) within e.g., 90 minutes, 60 minutes, 30 minutes, 15 minutes, 1 minute, etc. As will be appreciated, rapid freezing may prevent the formation of large ice crystals that could cause structural damage to the material. Rapid freezing may also limit the period of time at which the material is at a temperature conducive for bacterial growth or undesired chemical reactions.

In some embodiments, creating a vacuum may comprise activating the vacuum pump to reduce atmospheric pressure to a first pressure target and deactivating the vacuum pump upon reaching the first pressure target.

In some embodiments, progressively increasing the heater tray temperature without causing temperature cycling may comprise activating tray heater to increase tray temperature to a first consistent temperature, varying current through the tray heater to maintain tray temperature at the first consistent temperature for a first period of time, increasing current through the tray heater to increase tray temperature to a second consistent temperature, varying current through the tray heater to maintain tray temperature at the second consistent temperature for a second period of time, increasing current through the tray heater to increase tray temperature to a n consistent temperature, and varying current through the tray heater to maintain tray temperature at the n consistent temperature for a n period of time. It should be appreciated that certain materials and certain recipes may not reach n consistent temperature, instead reaching only the first consistent temperature or the second consistent temperature.

In some embodiments, the first, second, and n periods of time may be determined by providing pressure sensors, measuring the pressure, and detecting pressure conditions that indicate sublimation has stopped at the present consistent temperature to determine when the period of time should end. In such embodiments, the pressure sensors may comprise a capacitance manometer and a Pirani gauge. It will be understood that pressure conditions that indicate sublimation has stopped at the present consistent temperature may be detected when the pressure measurements from the capacitance manometer and a Pirani gauge are equal. In preferred embodiments, the pressure sensors may comprise at least one 531 thermocouple gauge tube. It will be appreciated that pressure conditions that indicate sublimation has stopped at the present consistent temperature may be detected when the pressure measurements from the at least one 531 thermocouple gauge tube are stable (i.e., do not change substantially) over a certain, pre-determined period of time.

In some embodiments, deactivating the tray heater may comprise reducing current through the tray heater to 0 A immediately or over such period of time as may be desirable.

In some embodiments, repressurizing the apparatus may comprise deactivating the vacuum pump, providing a filtered repressurization valve, and opening the valve to permit air from outside of the apparatus to flow through the valve and into the apparatus.

In some embodiments, removing the freeze-dried material may comprise removing the material from the heater tray or removing the heater tray from the apparatus.

In some embodiments, the present method may further comprise providing an actuated vent and actuating the vent-to-vent water vapor during freeze drying.

In some embodiments, the present method may further comprise providing a drain and permitting condensed water to flow out of the drain.

In some embodiments, the present method may further comprise providing a controller having a processor and programming the controller with a certain material-specific recipe. In some embodiments, the controller may be programmed wirelessly. In some embodiments, the controller may be programmed by a machine learning (AI) system.

Although a few embodiments have been shown and described, it will be appreciated by those skilled in the art that various changes and modifications can be made to these embodiments without changing or departing from their scope, intent, or functionality. These terms and expressions used in the preceding specification have been used herein as terms of description and not of limitation, and there is no intention in the use of such terms and expressions of excluding equivalents of the features shown and the described portions thereof.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A freeze-dryer apparatus comprising:
a cooling system;
a vacuum system or a vacuum system connector;
a vacuum chamber;
a food tray with a temperature sensor and a variable power heater, and located within the vacuum chamber; and
a controller connected to adjust and control a supply of continuous and non-zero power to the variable power heater to maintain the food tray within a predetermined range of temperature during a freeze-drying operation.

2. The freeze-dryer apparatus of claim 1 in which the variable power heater comprises a variable current heater.

3. The freeze-dryer apparatus of claim 2 further comprising a direct current (DC) power supply connected to supply power to the variable current heater.

4. The freeze-dryer apparatus of claim 1 in which the cooling system is connected to supply and return coolant to and from the vacuum chamber via a coolant loop.

5. The freeze-dryer apparatus of claim 4 in which the coolant loop comprises a coolant coil that encircles the vacuum chamber.

6. The freeze-dryer apparatus of claim 5 in which:
the vacuum chamber is defined by a vacuum chamber housing with side walls, a top, a base, a front, and rear wall; and
the coolant coil loops a plurality of times around the side walls, top, and base.

7. The freeze-dryer apparatus of claim 5 further comprising an insulative shroud around an exterior of the vacuum chamber.

8. The freeze-dryer apparatus of claim 1 in which the vacuum chamber is fluidly connected to vent evacuated air from the vacuum chamber to a condenser chamber.

9. The freeze-dryer apparatus of claim 1 in which the vacuum system comprises or is configured to connect to a vacuum pump that is connected to evacuate air from the vacuum chamber via a vacuum line.

10. The freeze-dryer apparatus of claim 1 further comprising an access door mounted to seal and unseal against a tray entry opening defined by the vacuum chamber.

11. The freeze-dryer apparatus of claim 10 in which:
the access door is mounted to a front of the vacuum chamber; and
a drip tray depends below the access door.

12. The freeze-dryer apparatus of claim 1 further comprising a pressure sensor in the vacuum chamber, in which the controller is connected to control operation of the freeze-drying operation based on data from the pressure sensor.

13. The freeze-dryer apparatus of claim 1 further comprising a fan configured to operate with the cooling system to blast chill an interior of the vacuum chamber during a freezing phase of a freeze-drying operation.

14. The freeze-dryer apparatus of claim 1 in which the controller is configured to operate a freeze-drying operation by initiating, in sequence:
a vacuum freeze mode which operates until air pressure is reduced in the vacuum chamber to at or below a threshold pressure;
a first heating phase where the supply of continuous and non-zero power to the variable power heater is adjusted to maintain the food tray at a first rate of temperature increase; and
a second heating phase where the supply of continuous and non-zero power to the variable power heater is adjusted to maintain the food tray at a second rate of temperature increase that is higher than the first rate of temperature increase.

15. The freeze-dryer apparatus of claim 14 in which the controller is configured to initiate a stall phase during one or both the first heating phase or the second heating phase when a pressure within the vacuum chamber remains above a high-pressure threshold for more than a predetermined amount of time.

16. The freeze-dryer apparatus of claim 15 in which the controller is configured to operate the stall phase by: shutting off power to the variable power heater; and returning to the first heating phase or second heating phase when a pressure within the vacuum chamber drops below the low-pressure threshold.

17. The freeze-dryer apparatus of claim 1 in which the controller is configured to store or access a database of freeze-drying operation recipes, and to display an edit-recipe user interface configured to allow a user to edit existing recipes and create novel recipes, which the controller is configured to store in the database for future use in a freeze-drying operation to be carried out by the freeze-dryer apparatus.

18. The freeze-dryer apparatus of claim 1 in which the food tray comprises a plurality of food trays, and the controller is connected to independently adjust and control a supply of continuous and non-zero power to the respective variable power heater of each respective food tray to maintain each food tray within a respective predetermined range of temperature during a freeze-drying operation.

19. A method comprising: cooling a food tray in a vacuum chamber, the food tray having a temperature sensor and a variable power heater; evacuating air in the vacuum chamber to put the vacuum chamber under partial vacuum; and while the vacuum chamber is under partial vacuum, heating the food tray to maintain a predetermined range of temperature by applying continuous non-zero power to the variable power heater.

20. The method of claim 19 in which applying further comprises: sensing a temperature of the food tray; and adjusting the continuous non-zero power to maintain the predetermined range of temperature.

21. The method of claim 19 in which heating further comprises: adjusting the continuous non-zero power to maintain the food tray at a first rate of temperature increase when in a first heating phase; and after the food tray climbs to a predetermined threshold temperature, adjusting the continuous non-zero power to maintain the food tray at a second rate of temperature increase, when in a second heating phase, that is higher than the first rate of temperature increase.

22. The method of claim 21 further comprising initiating a stall phase during one or both the first heating phase or the second heating phase when a pressure within the vacuum chamber remains above a high-pressure threshold for more than a predetermined amount of time.
